(19) United States
(12) Patent Application Publication
(10) Pub. No.: US 2026/0177063 A1
(43) Pub. Date: Jun. 25, 2026

(54) FAN WITH ROTATABLE BLOWER UNIT

(71) Applicant: Guangdong Aoyun Technology Co., Ltd., Huizhou (CN)

(72) Inventor: Xueping Zhu, Huizhou (CN)

(21) Appl. No.: 19/539,155

(22) Filed: Feb. 13, 2026

Related U.S. Application Data
(63) Continuation-in-part of application No. 19/074,023, filed on Mar. 7, 2025, now Pat. No. 12,553,451.
Application No. 19/074,023 is a continuation-in-part of application No. 18/629,587, filed on Apr. 8, 2024, now Pat. No. 12,270,417.

(30) Foreign Application Priority Data
Mar. 27, 2024 (CN) 202420615199.8
Feb. 6, 2026 (CN) 202620189694.6

(51) Int. Cl. F04D 25/06; F04D 29/60

(52) U.S. Cl. CPC F04D 25/0613; F04D 29/601

(57) ABSTRACT

A fan includes a fan body and a bracket assembly, wherein the fan body is connected to the bracket assembly, and the bracket assembly supports the fan body. The fan body includes a blower unit for air blowing and a main unit for controlling the blower unit. The blower unit includes a blowing component and a support bracket. The blowing component is used for blowing, and the support bracket is rotatably connected to the blowing component, and supports the blowing component. The support bracket is also rotatably connected to the main unit. The fan body further includes at least one first driving device, and the main unit is electrically connected to and drives the first driving device. The first driving device is respectively connected to the blowing component and the support bracket to drive the blowing component rotates relative to the support bracket.

### CROSS-REFERENCE TO RELATED APPLICATIONS

This application is a continuation-in-part of U.S. patent application Ser. No. 19/074,023, filed on Mar. 7, 2025, and entitled “FAN,” which is currently pending and is a continuation-in-part of U.S. patent application Ser. No. 18/629,587, filed on Apr. 8, 2024. This application also claims priority to Chinese Patent Application No. 2026201896946, filed on Feb. 6, 2026. The entire disclosures of the above-identified applications are incorporated herein by reference.

### TECHNICAL FIELD

The present invention relates to a field of fans, in particular to a fan.

### BACKGROUND ART

Most of the existing fans on the market require users to manually rotate the fan head to adjust the blowing angle. Traditional mechanical shafts are relatively rough to rotate and have average durability. This operation not only wastes users' energy, but also poses a risk of hand injury when adjusting the fan head angle by hand, greatly affecting the user experience. Therefore, the market urgently needs to provide a fan that can automatically adjust the blowing angle to improve the user experience.

### SUMMARY

In order to overcome the shortcomings of the prior art, the present invention provides a fan, comprising a fan body and a bracket assembly, wherein the fan body is connected to the bracket assembly, and the bracket assembly supports the fan body.

The fan body includes a blower unit for air blowing and a main unit for controlling the blower unit. The blower unit includes a blowing component and a support bracket. The blowing component is used for blowing, and the support bracket is rotatably connected to the blowing component, and supports the blowing component. The support bracket is also rotatably connected to the main unit.

The fan body further includes at least one first driving device, and the main unit is electrically connected to and drives the first driving device. The first driving device is respectively connected to the blowing component and the support bracket to drive the blowing component rotates relative to the support bracket.

The beneficial effects of the present invention are as follows: the present invention provides a fan, wherein a first driving device is provided between a blowing component and a support bracket, and the first driving device can be controlled to rotate by the main unit, so that the blowing component and the support bracket can rotate relative to each other to adjust the blowing angle of the blowing component in the up and down directions.

Preferably, there is a second driving device set between the blowing component and the main unit, which can be controlled to rotate through the main unit to adjust the blowing angle of the blowing component in the left and right directions. The fan is controlled by a motor to adjust the blowing angle, which is quieter, smoother, and more labor-saving, users do not need to manually rotate and adjust the fan, and the risk of being injured by the blade impeller when adjusting the blowing angle is also avoided, improving the user experience.

### BRIEF DESCRIPTION OF THE DRAWINGS

Implementations of the present invention will now be described, by way of embodiment, with reference to the attached figures. It should be understood, the drawings are shown for illustrative purpose only, for ordinary person skilled in the art, other drawings obtained from these drawings without paying creative labor by an ordinary person skilled in the art should be within scope of the present invention.

FIG. 1 is a schematic diagram of an overall structure of the fan according to Embodiment 1 of the present invention.

FIG. 2 is an exploded view of a fan according to Embodiment 1 of the present invention.

FIG. 3 is an enlarged view of Area A in FIG. 2.

FIG. 4 is another exploded view of the fan according to Embodiment 1.

FIG. 5 is an enlarged view of Area B in FIG. 3.

FIG. 6 is a schematic diagram of a structure of the fan according to Embodiment 1.

FIG. 7 is an enlarged view of Area C in FIG. 6.

FIG. 8 is a sectional view of an installation bracket and a supporting leg of the fan according to Embodiment 1.

FIG. 9 is an enlarged view of Area D in FIG. 8.

FIG. 10 is another sectional view of the installation bracket and the supporting leg of the fan according to Embodiment 1.

FIG. 11 is an enlarged view of Area E in FIG. 10.

FIG. 12 is a schematic diagram of an overall structure of the fan according to Embodiment 2 of the present invention.

FIG. 13 is an enlarged view of Area E in FIG. 12.

FIG. 14 is an enlarged view of Area F in FIG. 12.

FIG. 15 is a schematic diagram of the overall structure of the fan from another angle according to Embodiment 2 of the present invention.

FIG. 16 is an exploded view of the fan according to Embodiment 2.

FIG. 17 is an enlarged view of Area G in FIG. 16.

FIG. 18 is a schematic diagram of an overall structure of a fan according to Embodiment 3 of the present invention.

FIG. 19 is an enlarged view of the G part of FIG. 18.

FIG. 20 is another schematic diagram of an overall structure of the fan of FIG. 18.

FIG. 21 is an exploded view of a fan body of the fan of FIG. 18.

FIG. 22 is another view of FIG. 21.

FIG. 23 is a cross sectional view of the fan body of the fan of FIG. 18.

FIG. 24 is an enlarged view of H part of FIG. 23.

FIG. 25 is an enlarged view of I part of FIG. 23.

FIG. 26 is an enlarged view of J part of FIG. 23.

FIG. 27 is a partially exploded view of a blower unit of the fan of FIG. 18.

FIG. 28 is another view of FIG. 27.

FIG. 29 is an exploded view of a blowing component of the fan of FIG. 18.

FIG. 30 is an enlarged view of K part of FIG. 29.

FIG. 31 is another view of FIG. 29.

FIG. 32 is an enlarged view of L part of FIG. 31.

FIG. 33 is a schematic diagram of an air outlet hood of a fan according to Embodiment 3 of the present invention, and shows airflow guidance of the air outlet hood.

FIG. 34 is another partially exploded view of the blower unit of the fan of FIG. 18.

FIG. 35 is another exploded view of a fan body of the fan of FIG. 18.

FIG. 36 is further another partially exploded view of the blower unit of the fan of FIG. 18.

FIG. 37 is another view of FIG. 36.

FIG. 38 is an enlarged view of N part of FIG. 37.

FIG. 39 is another partially exploded view of a blowing component of the fan of FIG. 18.

FIG. 40 is cross sectional view of an air gathering ring the fan of FIG. 18.

FIG. 41 is a schematic diagram of a fan according to Embodiment 4 of the present invention.

FIG. 42 is another schematic diagram of the fan according to Embodiment 4 of the present invention.

FIG. 43 is a schematic diagram of an air inlet hood of the fan of FIG. 41.

FIG. 44 is an exploded view of a blowing component of the fan of FIG. 41.

FIG. 45 is an enlarged view of the M part of FIG. 43.

FIG. 46 is another exploded view of a blowing component of the fan of FIG. 41.

FIG. 47 shows a remote controller for the fan according to a first embodiment of the present invention.

FIG. 48 shows a back view of the remote controller for the fan of FIG. 47.

FIG. 49 shows a remote controller for the fan according to a second embodiment of the present invention.

FIG. 50 shows a back view of the remote controller for the fan of FIG. 49.

FIG. 51 shows a remote controller for the fan according to a third embodiment of the present invention.

FIG. 52 shows a back view of the remote controller for the fan of FIG. 51.

FIG. 53 is a schematic diagram of a fan according to Embodiment 5 of the present invention.

FIG. 54 is another schematic diagram of the fan according to Embodiment 5 of the present invention.

FIG. 55 is a schematic diagram of the fan according to Embodiment 6 of the present invention.

FIG. 56 is another schematic diagram of the fan according to Embodiment 6 of the present invention.

FIG. 57 is a schematic diagram of the fan according to Embodiment 7 of the present invention.

FIG. 58 is another schematic diagram of the fan according to Embodiment 7 of the present invention.

FIG. 59 is a schematic diagram of the fan according to Embodiment 8 of the present invention.

FIG. 60 is another schematic diagram of the fan according to Embodiment 8 of the present invention.

FIG. 61 is a schematic diagram of the fan according to Embodiment 9 of the present invention.

FIG. 62 is another schematic diagram of the fan according to Embodiment 9 of the present invention.

FIG. 63 is a schematic diagram of the fan according to Embodiment 10 of the present invention.

FIG. 64 is another schematic diagram of the fan according to Embodiment 10 of the present invention.

FIG. 65 is a schematic diagram of the fan in a using state according to Embodiment 10 of the present invention.

FIG. 66 is a schematic diagram of the fan according to Embodiment 11 of the present invention.

FIG. 67 is another schematic diagram of the fan according to Embodiment 11 of the present invention.

FIG. 68 is a schematic diagram of the fan according to Embodiment 12 of the present invention.

FIG. 69 is another schematic diagram of the fan according to Embodiment 12 of the present invention.

FIG. 70 is a schematic diagram of the fan according to Embodiment 13 of the present invention.

FIG. 71 is another schematic diagram of the fan according to Embodiment 13 of the present invention.

### DETAILED DESCRIPTION OF THE EMBODIMENTS

It will be appreciated that for simplicity and clarity of illustration, where appropriate, reference numerals have been repeated among the different figures to indicate corresponding or analogous elements. In addition, numerous specific details are set forth in order to provide a thorough understanding of the exemplary embodiments described herein. However, it will be understood by those of ordinary skill in the art that the exemplary embodiments described herein may be practiced without these specific details. In other instances, methods, procedures, and components have not been described in detail so as not to obscure the related relevant feature being described. Also, the description is not to be considered as limiting the scope of the exemplary embodiments described herein. The drawings are not necessarily to scale and the proportions of certain parts may be exaggerated to better illustrate details and features of the present invention.

The term “comprising” when utilized, means “including, but not necessarily limited to”; it specifically indicates open-ended inclusion or membership in the so-described combination, group, series, and the like. The invention is illustrated by way of example and not by way of limitation in the figures of the accompanying drawings in which like references indicate similar elements. It should be noted that references to “an” or “one” embodiment in this invention are not necessarily to the same embodiment, and such references can mean “at least one”. In addition, the terms “first” and “second” are used for descriptive purposes only and cannot be understood as indicating or implying relative importance or implying the number of indicated technical features. Thus, the features defined as “first” and “second” may explicitly or implicitly include one or more of the features. In the description of embodiments of the application, “a plurality of” means two or more, unless otherwise specifically defined.

### Embodiment 1

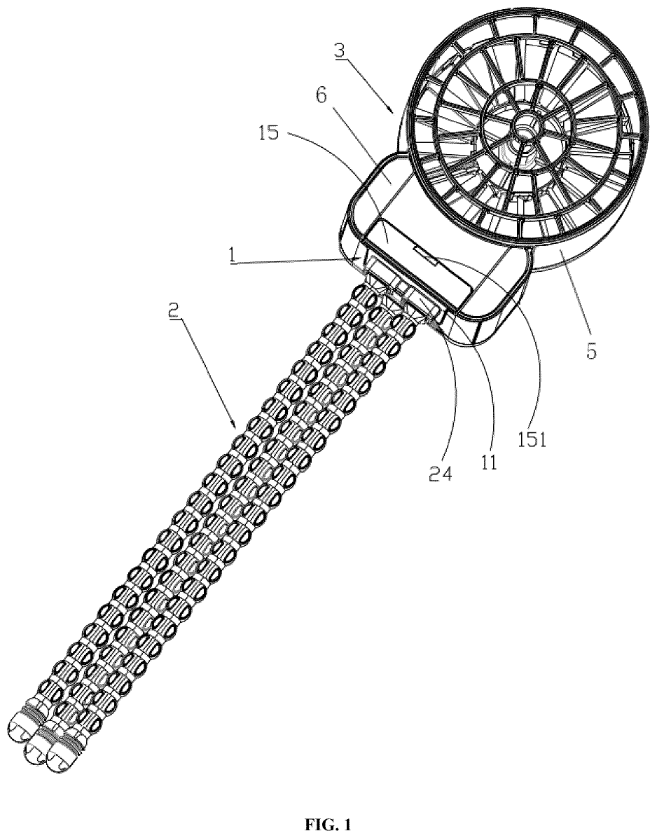

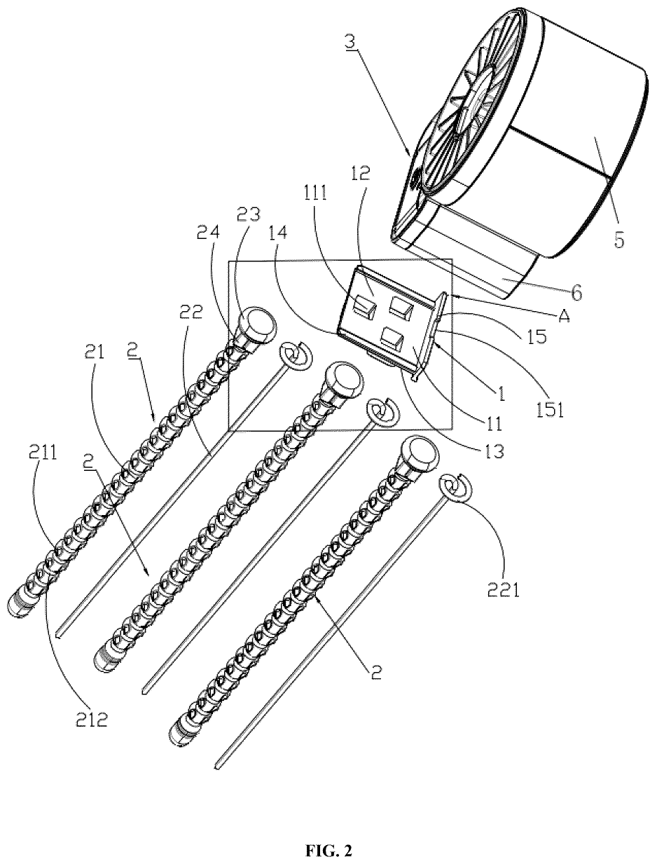

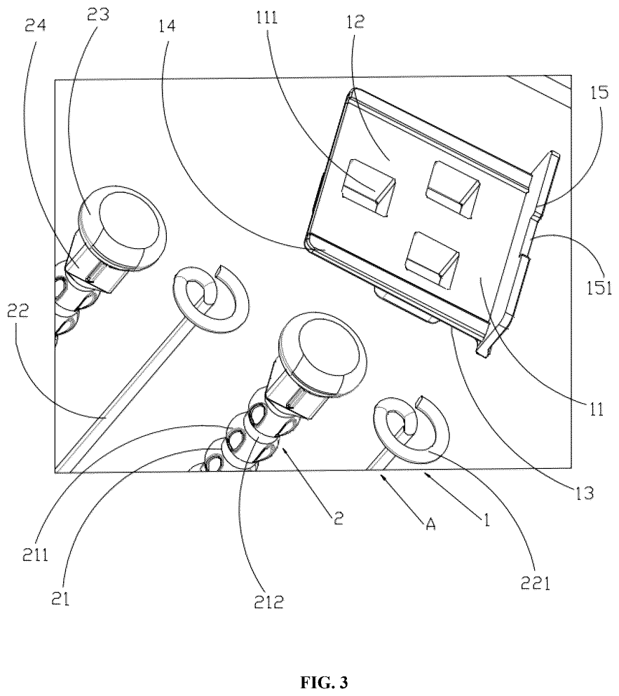

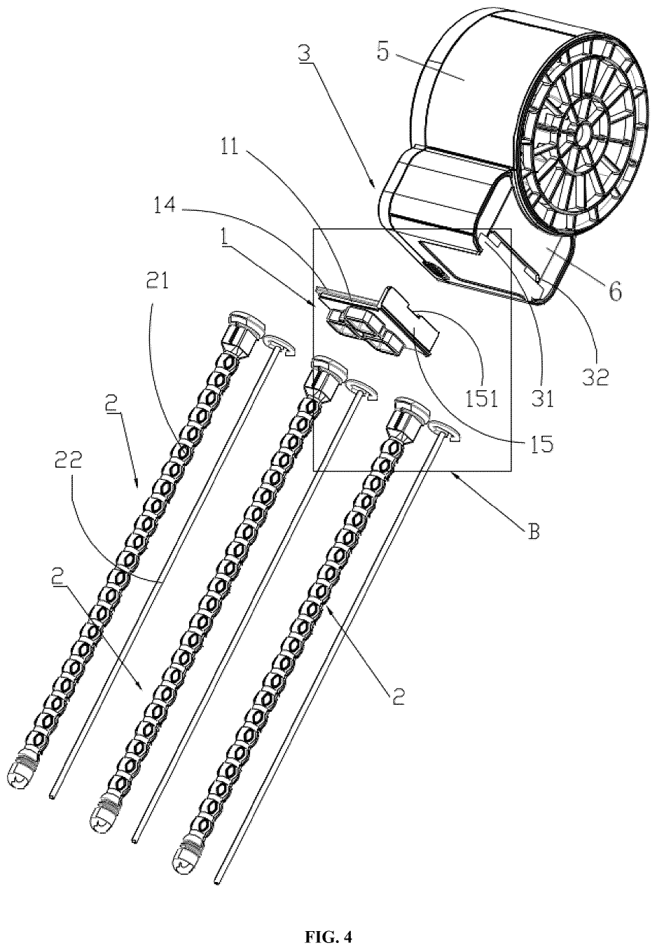

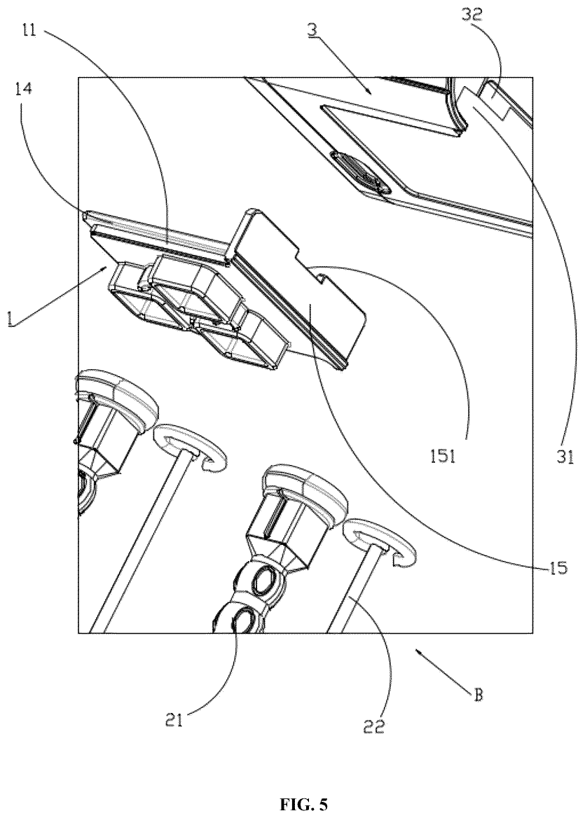

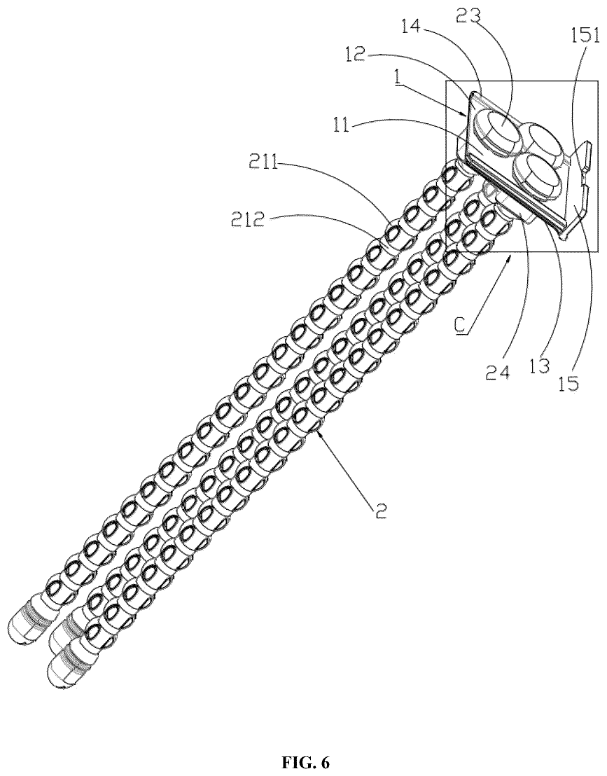

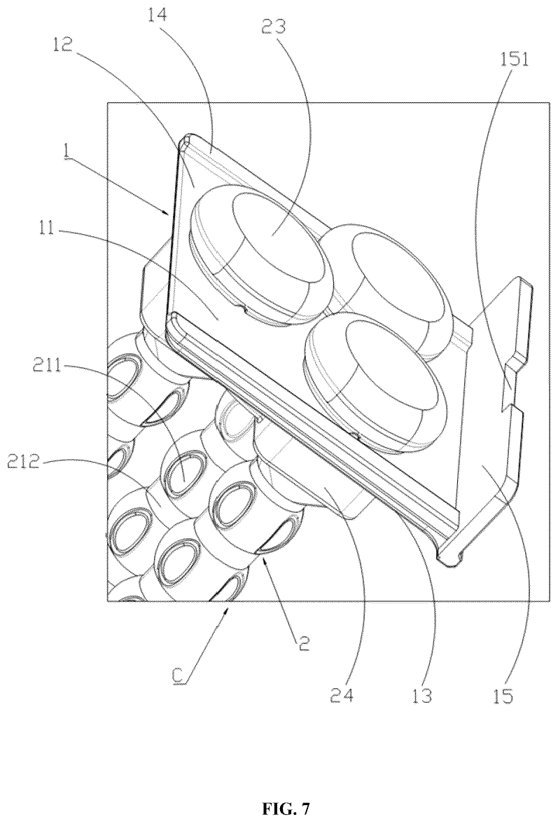

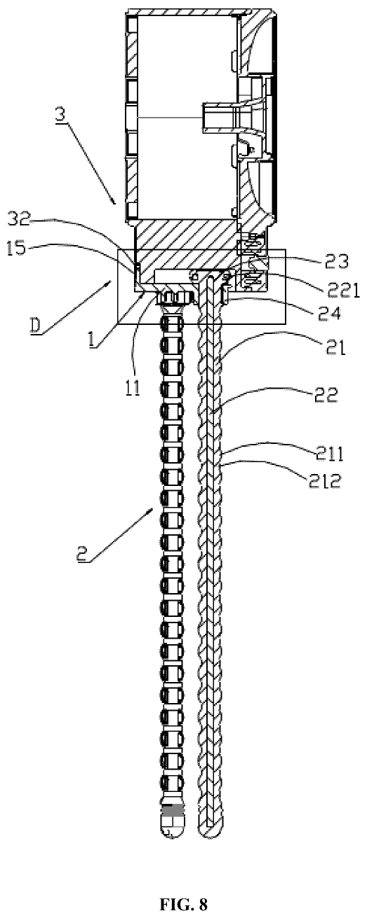

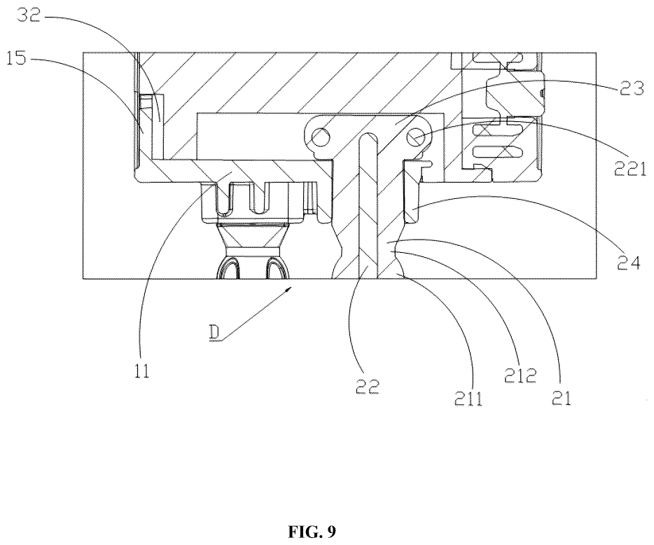

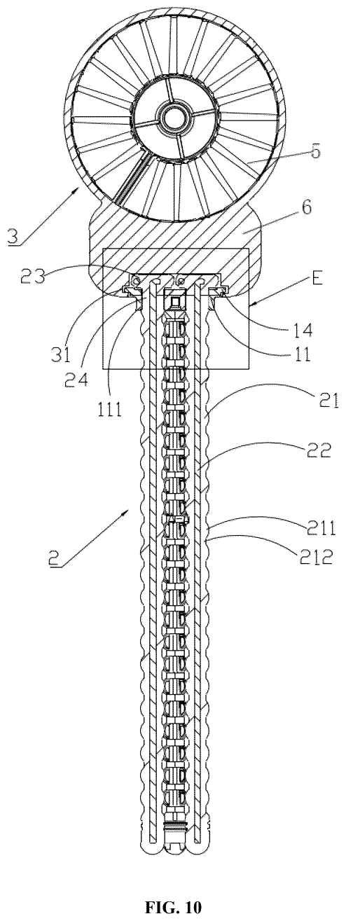

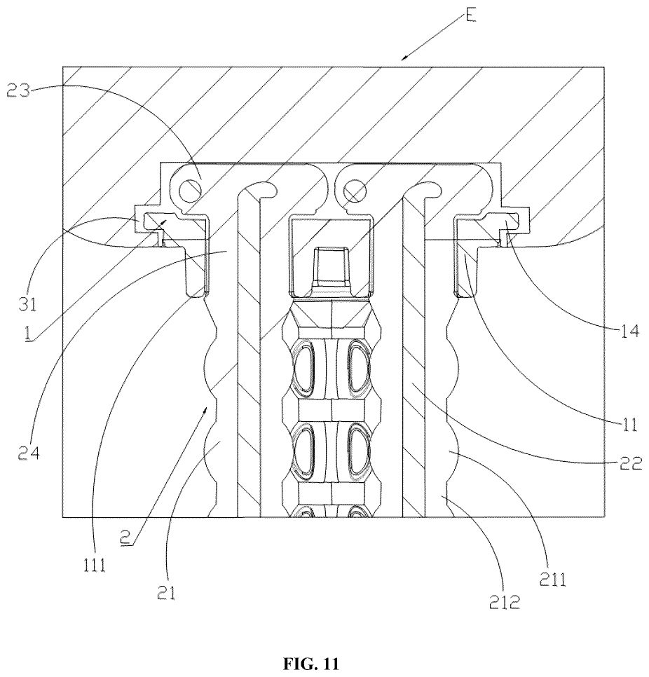

Referring to FIGS. 1-11, a bracket assembly includes: an installation bracket 1, the installation bracket 1 being equipped with an installation part 11; and at least one bendable and shapeable supporting leg 2, the supporting leg 2 being connected to the installation part 11.

Through the above structure, the bracket assembly includes the installation bracket 1 and at least one bendable and shapeable supporting leg 2, the installation bracket 1 is equipped with the installation part 11, and the supporting leg 2 is connected to the installation part 11. Therefore, users can connect the installation bracket 1 to an external device, thereby attaching the bendable and shapeable supporting leg 2 to the external device, so that the external device can be suspended or supported on an external object through the bendable and shapeable supporting leg 2. At the same time, a support angle of the supporting leg 2 can be adjusted by bending the supporting leg 2, so as to adjust an angle of the external device. Moreover, a total number of the supporting legs 2 can be set to 3-10, so that the supporting legs 2 can be combined with each other to form an octopus shape to provide more stable support. For example, when it is necessary to hang the external device on a shelf, the supporting leg 2 can be bent into an annular shape, so as to hang the supporting leg 2 on the shelf, and a hanging angle of the external device can be adjusted through the bendable supporting leg 2. For another example, when it is necessary to place the external device on a flat surface such as a desktop, the supporting leg 2 can be bent to form a support surface, so as to place the supporting leg 2 on the flat surface such as the desktop, and a placement angle of the external device can be adjusted trough the bendable supporting leg 2.

The external device can be a fan, a phone holder, a humidifier, a desk lamp, a desktop decoration and other devices.

In this embodiment, the supporting leg 2 includes a flexible protective sleeve 21, and a bendable and shapeable metal wire 22. The metal wire 22 is arranged inside the flexible protective sleeve 21, so that the flexible protective sleeve 21 covers the metal wire 22. Specifically, the flexible protective sleeve 21 includes a plurality of protrusions 211 and a plurality of grooves 212. The plurality of protrusions 211 and the plurality of grooves 212 are arranged at intervals with each other. Specifically, the flexible protective sleeve 21 is a silicone protective sleeve or a rubber protective sleeve. Through the above structure, by covering the metal wire 22 with the flexible protective sleeve 21, the characteristics of the metal wire 22 being bendable and shapeable can be utilized, so that the external device can be suspended or supported on the external object through the bendable and shapeable metal wire 22. Moreover, the flexible protective sleeve 21 covered on a surface is capable of protecting the metal wire 22, while making the supporting leg 2 more beautiful and tactile. Furthermore, since the flexible protective sleeve 21 includes the plurality of protrusions 211 and the plurality of grooves 212, and the protrusions 211 and the grooves 212 are arranged at intervals with each other, the metal wire 22 of the supporting leg 2 can be bent at the grooves 212, resulting in better shaping effect and effectively improving the stability of the supporting leg 2. This facilitates an adjustment of the support angle of the supporting leg 2 to adjust the angle of the external device.

In this embodiment, the supporting leg 2 is detachably connected to the installation part 11. The installation part 11 is equipped with an installation opening 111, and the supporting leg 2 is inserted into the installation opening 111. Specifically, one end of the supporting leg 2 is equipped with a first stop part 23. The supporting leg 2 passes through the installation opening 111 from an upper surface 12 of the installation bracket 1 to a lower surface 13 of the installation bracket 1. The installation bracket 1 keeps the first stop part 23 on the upper surface 12 of the installation bracket 1. Specifically, the metal wire 22 extends from a first end of the flexible protective sleeve 21 to a second end of the flexible protective sleeve 21. An end of the metal wire 22 is equipped with a stop ring 221. The stop ring 221 is positioned within the first stop part 23. Furthermore, the supporting leg 2 is further equipped with an insertion part 24. The insertion part 24 is inserted into the installation opening 111. Through the above structure, an installation of the supporting leg 2 and the installation bracket 1 is effectively achieved, making it convenient for users to install the supporting leg 2 on the installation bracket 1. During a production process, the supporting leg 2 and the installation bracket 1 can be separately formed, and then the supporting leg 2 can be combined with the installation bracket 1 to form the bracket assembly, thereby effectively improving production efficiency and product yield (i.e., manufacturing yield).

In this embodiment, the installation bracket 1 is further provided with a sliding block 14. The sliding block 14 is used for connecting to a sliding groove of the external device. Through the above structure, the sliding block 14 on the installation bracket 1 can slide into the sliding groove of the external device to complete an installation of the bracket assembly, thereby attaching the bendable and shapeable supporting leg 2 to the external device, so that the external device can be suspended or supported on an external object through the bendable and shapeable supporting leg 2. At the same time, a support angle of the supporting leg 2 can be adjusted by bending the supporting leg 2, so as to adjust a angle of the external device. For example, when it is necessary to hang the external device on a shelf, the supporting leg 2 can be bent into an annular shape, so as to hang the supporting leg 2 on the shelf, and a hanging angle of the external device can be adjusted through the bendable supporting leg 2. For another example, when it is necessary to place the external device on a flat surface such as a desktop, the supporting leg 2 can be bent to form a support surface, so as to place the supporting leg 2 on the flat surface such as the desktop, and a placement angle of the external device can be adjusted trough the bendable supporting leg 2.

Referring to FIGS. 1-11, a fan with a bracket assembly includes: a main body of fan 3, the main body of fan 3 being equipped with an installation fitting part 31; and a bracket assembly. The bracket assembly includes an installation bracket 1 and at least one bendable and shapeable supporting leg 2. The installation bracket 1 is equipped with an installation part 11. The supporting leg 2 is connected to the installation part 11. The installation part 11 is connected to the installation fitting part 31.

Through the above structure, the fan with the bracket assembly includes the main body of fan 3 and the bracket assembly. The main body of fan 3 is equipped with the installation fitting part 31. The bracket assembly includes the installation bracket 1 and at least one bendable and shapeable supporting leg 2. The installation bracket 1 is equipped with the installation part 11. The supporting leg 2 is connected to the installation part 11, and the installation part 11 is connected to the installation fitting part 31. Therefore, users can connect the installation bracket 1 to the main body of fan 3, thereby attaching the bendable and shapeable supporting leg 2 to the main body of fan 3, so that the fan body 3 can be suspended or supported on an external object through the bendable and shapeable supporting leg 2. At the same time, a support angle of the supporting leg 2 can be adjusted by bending the supporting leg 2, so as to adjust an angle of the main body of fan 3. Moreover, a total number of the supporting leg 2 can be set to 3-10, so that the supporting legs 2 can be combined with each other to form an octopus shape to provide more stable support. For example, when it is necessary to hang the main body of fan 3 on a shelf, the supporting leg 2 can be bent into an annular shape to hang the supporting leg 2 on the shelf, and a hanging angle of the main body of fan 3 can be adjusted through the bendable supporting leg 2. For another example, when it is necessary to place the main body of fan 3 on a flat surface such as a desktop, the supporting leg 2 can be bent to form a supporting surface, so as to place the supporting leg 2 on the flat surface such as the desktop, and a placement angle of the main body of fan 3 can be adjusted through the bendable supporting leg 2.

In this embodiment, the supporting leg 2 includes a flexible protective sleeve 21 and a bendable and shapeable metal wire 22. The metal wire 22 is arranged inside the flexible protective sleeve 21, so that the flexible protective sleeve 21 covers the metal wire 22. Specifically, the flexible protective sleeve 21 includes a plurality of protrusions 211 and a plurality of grooves 212. The plurality of protrusions 211 and the plurality of grooves 212 are arranged at intervals with each other. Specifically, the flexible protective sleeve 21 is a silicone protective sleeve or a rubber protective sleeve. Through the above structure, by covering the metal wire 22 with the flexible protective sleeve 21, the characteristics of the metal wire 22 being bendable and shapeable can be utilized, so that an external device can be suspended or supported on an external object through the bendable and shapeable metal wire 22. Moreover, the flexible protective sleeve 21 covered on a surface is capable of protecting the metal wire 22, while making the supporting leg 2 more beautiful and tactile. Furthermore, since the flexible protective sleeve 21 includes the plurality of protrusions 211 and the plurality of grooves 212, and the protrusions 211 and the grooves 212 are arranged at intervals with each other, the metal wire 22 of the supporting leg 2 can be bent at the grooves 212, resulting in better shaping effect and effectively improving the stability of the supporting leg 2. This facilitates an adjustment of the support angle of the supporting leg 2 to adjust an angle of the external device.

In this embodiment, the supporting leg 2 is detachably connected to the installation part 11. The installation part 11 is equipped with an installation opening 111, and the supporting leg 2 is inserted into the installation opening 111. Specifically, one end of the supporting leg 2 is equipped with a first stop part 23. The supporting leg 2 passes through the installation opening 111 from an upper surface 12 of the installation bracket 1 to a lower surface 13 of the installation bracket 1. The installation bracket 1 keeps the first stop part 23 on the upper surface 12 of the installation bracket 1. Specifically, the metal wire 22 extends from a first end of the flexible protective sleeve 21 to a second end of the flexible protective sleeve 21. An end of the metal wire 22 is equipped with a stop ring 221. The stop ring 221 is positioned within the first stop part 23. Furthermore, the supporting leg 2 is further equipped with an insertion part 24. The insertion part 24 is inserted into the installation opening 111. Through the above structure, an installation of the supporting leg 2 and the installation bracket 1 is effectively achieved, making it convenient for users to install the supporting leg 2 on the installation bracket 1. During a production process, the supporting leg 2 and the installation bracket 1 can be separately formed, and then the supporting leg 2 can be combined with the installation bracket 1 to form the bracket assembly, thereby effectively improving production efficiency and product yield (i.e., manufacturing yield).

In this embodiment, the installation bracket 1 is further provided with a sliding block 14. The installation fitting part 31 is a sliding groove, and the sliding block 14 is connected to the sliding groove. When the sliding block 14 is connected to the sliding groove, the installation bracket 1 and an inner wall of the sliding groove cooperatively clamp the first stop part 23. Specifically, the installation bracket 1 includes the installation part 11 and a second stop part 15. The installation part 11 is connected to the second stop part 15, and the installation part 11 and the second stop part 15 are arranged at an obtuse angle, an acute angle or a right angle. The main body of fan 3 is provided with a stop groove 32, and the sliding block 14 is positioned on the installation part 11. When the sliding block 14 is connected to the sliding groove, the second stop part 15 is connected to the stop groove 32. Furthermore, the second stop part 15 is equipped with a hollow handle 151. Through the above structure, the sliding block 14 on the installation bracket 1 can slide into the sliding groove of the main body of fan 3 to complete an installation of the bracket assembly, thereby attaching the bendable and shapeable supporting leg 2 to the main body of fan 3, so that the main body of fan 3 can be suspended or supported on an external object through the bendable and shapeable supporting leg 2. At the same time, a support angle of the supporting leg 2 can be adjusted by bending the supporting leg 2, so as to adjust an angle of the main body of fan 3. For example, when it is necessary to hang the main body of fan 3 on a shelf, the supporting leg 2 can be bent into an annular shape, so as to hang the supporting leg 2 on the shelf, and a hanging angle of the main body of fan 3 can be adjusted through the bendable supporting leg 2. For another example, when it is necessary to place the main body of fan 3 on a flat surface such as a desktop, the supporting leg 2 can be bent to form a support surface, so as to place the supporting leg 2 on the flat surface such as the desktop, and a placement angle of the main body of fan 3 can be adjusted trough the bendable supporting leg 2.

It can be understood that in this embodiment, the main body of fan 3 includes a blower part 5 and a main unit 6. The blower part 5 is connected to the main unit 6. The main unit 6 integrates a control mainboard, a battery, a switch button, and other components, and is configured to control power supply to the blower part 5. By integrating all control electronic components within the main unit 6, the integration level of components is improved, space is saved, and user control is simplified. Additionally, the absence of control electronic components in the blower part 5 enables a more compact structure, reduced size, and streamlined design, thereby facilitating manufacturing and enhancing aesthetic appeal.

### Embodiment 2

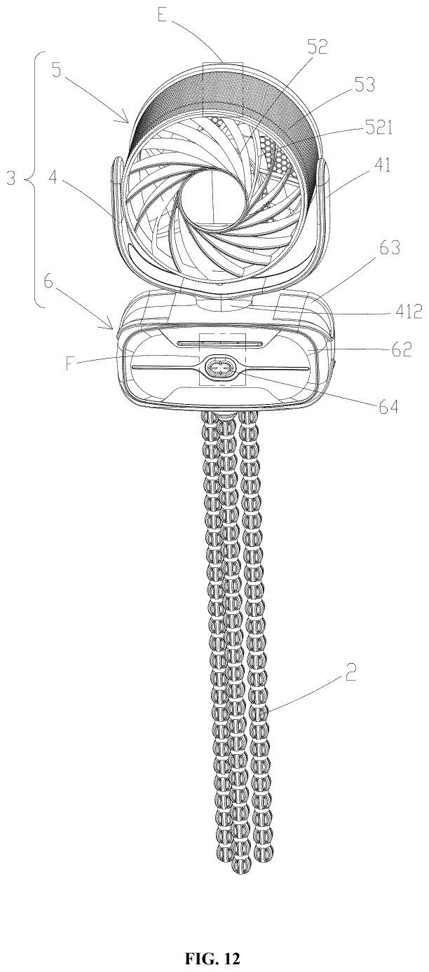

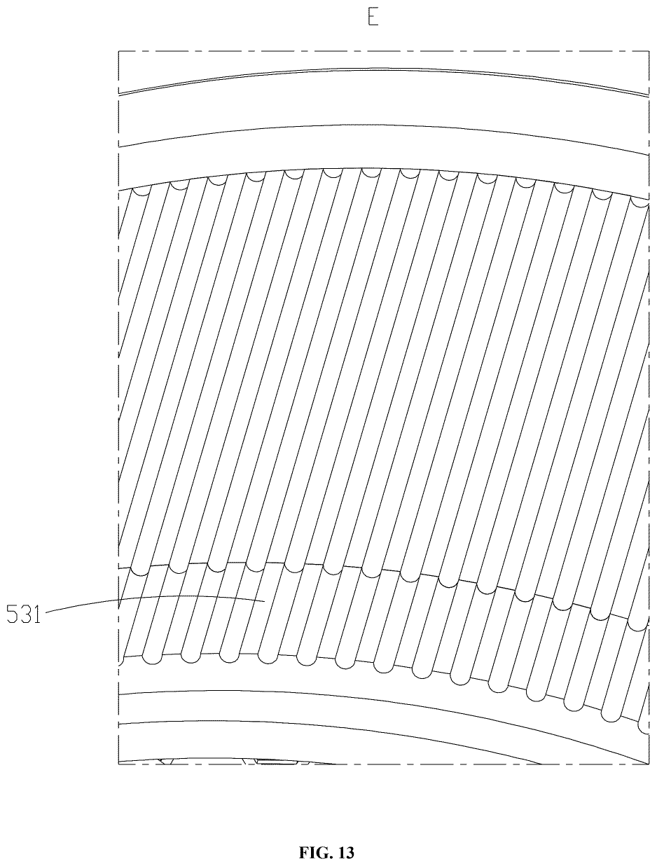

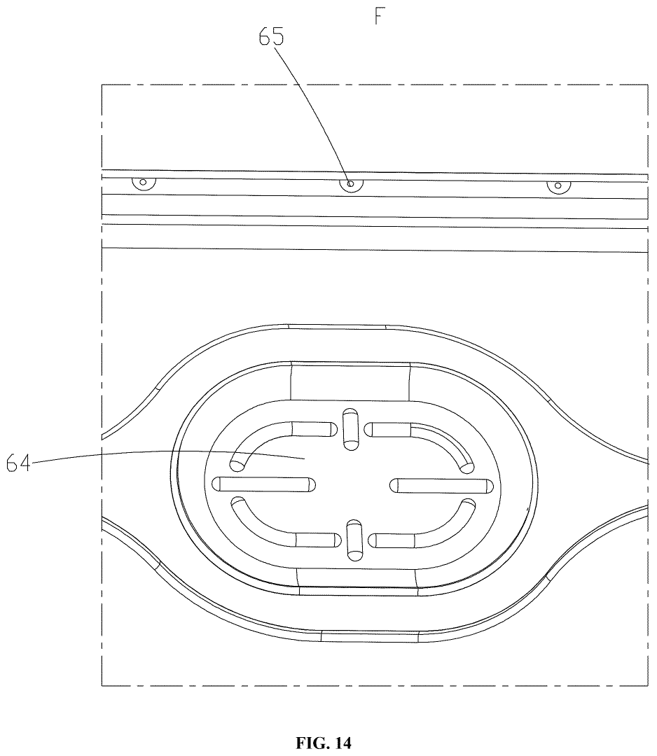

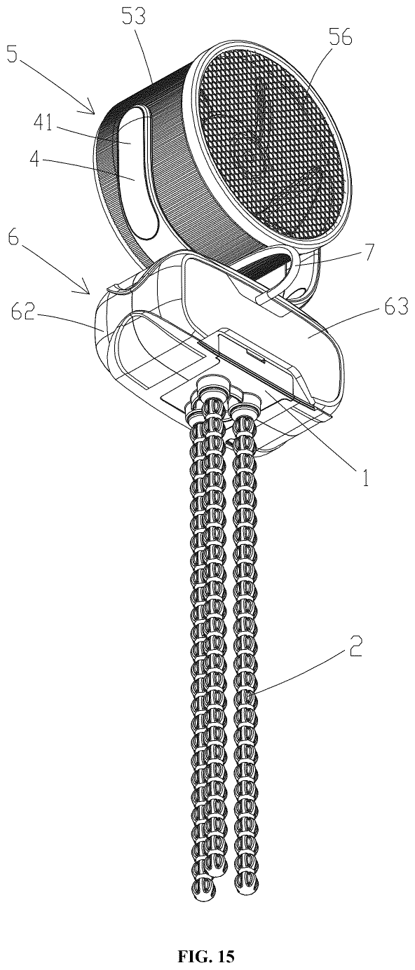

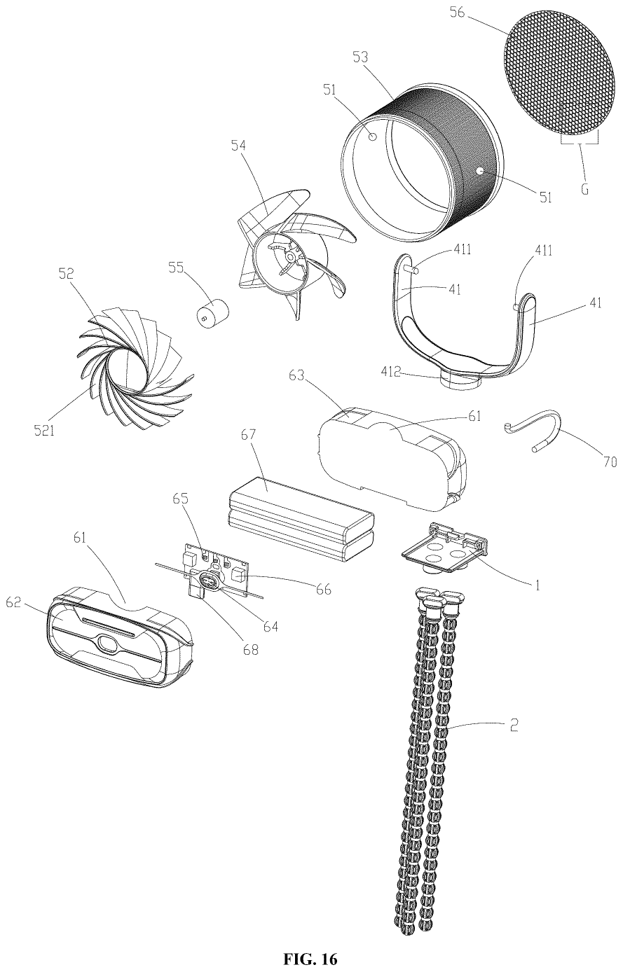

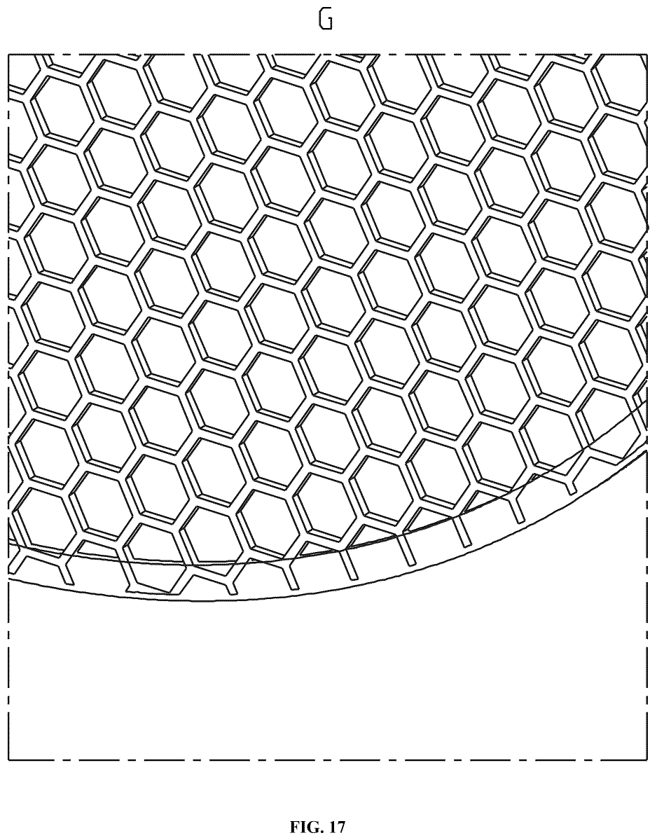

Referring to FIGS. 12 to 17, a fan is provided, formed by connecting a main body of fan 3 and a bracket assembly. The main body of fan 3 includes a blower part 5 for airflow generation, a rotating bracket 4, and a main unit 6. The blower part 5, rotating bracket 4, and main unit 6 are sequentially connected from top to bottom. The main unit 6 is configured to control power supply to the blower part 5. The rotating bracket 4 is rotatably connected to both the blower part 5 and the main unit 6, thereby enabling the blower part 5 to adjust the blowing angle through rotation. The bracket assembly includes at least one bendable and shapeable supporting leg 2, configured to fix the fan to an external object.

Through the above structure, this embodiment provides a rotatable fan equipped with supporting legs 2. The rotating bracket 4 is rotatably connected to both the blower part 5 and the main unit 6, enabling multi-angle airflow adjustment of the blower part 5 when the fan is fixed, thereby providing a better user experience. At least one bendable and shapeable supporting leg 2 allows the fan to be suspended or supported on an external object. The supporting leg 2 can be bent to precisely adjust the fan's orientation and height. Furthermore, the number of supporting legs 2 can be configured to range from 3 to 10, forming an octopus-shaped configuration to provide stable support.

Specifically, the rotating bracket 4 is U-shaped, and both sides of the rotating bracket 4 are equipped with connecting arms 41. The two connecting arms 41 provide stable support for the blower part 5. A first connection shaft 411 is arranged on the inner wall of each connecting arm 41, and the blower part 5 is equipped with a first connection hole 51 matching the first connection shaft 411. The first connection shaft 411 is inserted into the first connection hole 51, allowing the blower part 5 to rotate relative to the rotating bracket 4 in a vertical direction about the first connection shaft 411. Preferably, the first connection shaft 411 and the first connection hole 51 are configured for damped rotation, thereby fixing the blower part 5 at a desired angle without reverting to their original positions due to gravity.

A second connection shaft 412 is arranged at a central position below the rotating bracket 4. A corresponding second connection hole 61 is provided on a housing of the main unit 6. The second connection shaft 412 matches the second connection hole 61. By inserting the second connection shaft 412 into the second connection hole 61, the blower part 5 and the rotating bracket 4 are enabled to rotate relative to the main unit 6 in a horizontal direction about the second connection shaft 412. Preferably, the second connection shaft 412 and the second connection hole 61 are configured for damped rotation, thereby enabling the blower part 5 and the rotating bracket 4 to be fixed at a desired angle after rotation.

Through the above structure, the blower part 5 is enabled to adjust the blowing angle in both horizontal and vertical directions, facilitating users to adjust more blowing angles and thus enhancing user experience.

In this embodiment, the blower part 5 includes an air outlet hood 52, a surrounding outer wall 53, blade impeller 54, a motor 55, and an air inlet hood 56. The outer wall 53 is circumferentially arranged. The air outlet hood 52 and the air inlet hood 56 are oppositely positioned at two ends of the outer wall 53. The motor 55 and the blade impeller 54 are arranged inside the outer wall 53, and the motor 55 is connected to the blade impeller 54 to drive rotation of the blade impeller 54. The air inlet hood 56 has hexagonal mesh holes, which is beneficial for making the air inlet hood 56 thinner in the manufacturing process. The air outlet hood 52 is equipped with a plurality of spiral blades 521 arranged sequentially, which enhances airflow concentration and boosts the wind force generated by the blade impeller 54, thereby improving users experience. Further, the first connection hole 51 is positioned on the outer wall 53.

In this embodiment, the main unit 6 includes a first shell 62 and a second shell 63. The first shell 62 and the second shell 63 are connected to form an accommodating space. The second connection hole 61 is positioned at a junction of the first shell 62 and the second shell 63. The main unit 6 further comprises a switch button 64, an indicator light 65, and a power interface 68 arranged on the first shell 62, as well as a control mainboard 66 and a battery 67 arranged within the accommodating space. The battery 67 is electrically connected to the control mainboard 66, thereby supplying power to the entire fan. The switch button 64, the indicator light 65, and the power interface 68 are electrically connected to the control mainboard 66. The switch button 64 is configured to control activation/deactivation and speed levels of the fan through user pressing. The indicator light 65 is configured to indicate battery level and speed levels of the fan. Preferably, the power interface 68 is a Type-C or USB interface, allowing users to charge the fan via the power interface 68.

In this embodiment, the blower part 5 and the main unit 6 are electrically connected through an external conductive wire 7. Specifically, the motor 55 is electrically connected to the control mainboard 66 via the conductive wire 7. The main unit 6 supplies power to and controls activation/deactivation of the blower part 5 through the external conductive wire 7, achieving a simple and rational design.

In this embodiment, the bracket assembly further includes an installation bracket 1. The installation bracket 1 is equipped with an installation part 11, and the supporting leg 2 is detachably connected to the installation part 11. The main unit 6 is equipped with an installation fitting part 31, and the installation part 11 is connected to the installation fitting part 31. The installation part 11 is equipped with an installation opening 111, and the supporting leg 2 is inserted into the installation opening 111. Specifically, one end of the supporting leg 2 is equipped with a first stop part 23. The supporting leg 2 passes through the installation opening 111 from an upper surface 12 of the installation bracket 1 to a lower surface 13 of the installation bracket 1. The installation bracket 1 retains the first stop part 23 on the upper surface 12 of the installation bracket 1. Specifically, the metal wire 22 extends from one end of the flexible protective sleeve 21 to the other end of the flexible protective sleeve 21. An end of the metal wire 22 is equipped with a stop ring 221, and the stop ring 221 is positioned within the first stop part 23. Further, the supporting leg 2 is additionally equipped with an insertion part 24, and the insertion part 24 is inserted into the installation opening 111. Through the above structure, the connection between the supporting leg 2 and the installation bracket 1 is effectively realized, facilitating users installation of the supporting leg 2 onto the installation bracket 1. During manufacturing, the supporting leg 2 and the installation bracket 1 can be separately formed and subsequently assembled into the bracket assembly, thereby improving production efficiency and product yield.

In this embodiment, the supporting leg 2 includes a flexible protective sleeve 21 and a bendable and shapeable metal wire 22. The metal wire 22 is arranged inside the flexible protective sleeve 21, such that the flexible protective sleeve 21 covers the metal wire 22. Specifically, the flexible protective sleeve 21 comprises a plurality of protrusions 211 and a plurality of grooves 212. The protrusions 211 and the grooves 212 are arranged at intervals with each other. Specifically, the flexible protective sleeve 21 is a silicone protective sleeve or a rubber protective sleeve. Through the above structure, the flexible protective sleeve 21 covering the metal wire 22 allows utilization of the bendable and shapeable characteristics of the metal wire 22, thereby enabling the external device to be suspended or supported on an external object via the bendable and shapeable metal wire 22. Additionally, the flexible protective sleeve 21 on the surface protects the metal wire 22 while improving the aesthetic appeal and tactile feel of the supporting leg 2. Furthermore, since the flexible protective sleeve 21 comprises the protrusions 211 and grooves 212 arranged at intervals, the metal wire 22 of the supporting leg 2 can be bent at the grooves 212, achieving superior shaping effects and effectively enhancing the stability of the supporting leg 2. This facilitates adjustment of the supporting angle of the supporting leg 2 to regulate the angle of the external device.

In this embodiment, the installation bracket 1 is further equipped with a sliding block 14, configured to connect to a sliding groove of an external device. Through the above structure, the sliding block 14 on the installation bracket 1 can be slid into the sliding groove of the external device, thereby completing installation of the bracket assembly and attaching the bendable and shapeable supporting leg 2 to the external device. This allows the external device to be suspended or supported on an external object via the bendable and shapeable supporting leg 2. Additionally, the supporting angle of the supporting leg 2 can be adjusted by bending it, thereby regulating the angle of the external device. For example, when it is necessary to suspend the external device on a shelf, the supporting leg 2 can be bent into an annular shape to hang the supporting leg 2 on the shelf, and the suspension angle of the external device can be adjusted through the bendable supporting leg 2. For another example, when it is necessary to place the external device on a flat surface such as a desktop, the supporting leg 2 can be bent to form a support surface, allowing it to rest on the desktop, and the placement angle of the external device can be adjusted via the bendable supporting leg 2.

### Embodiment 3

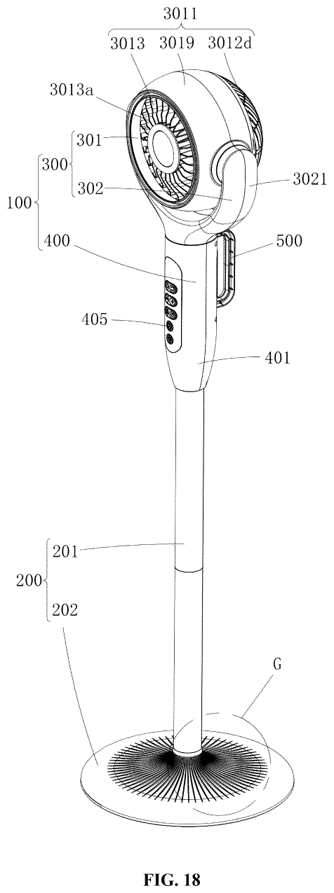

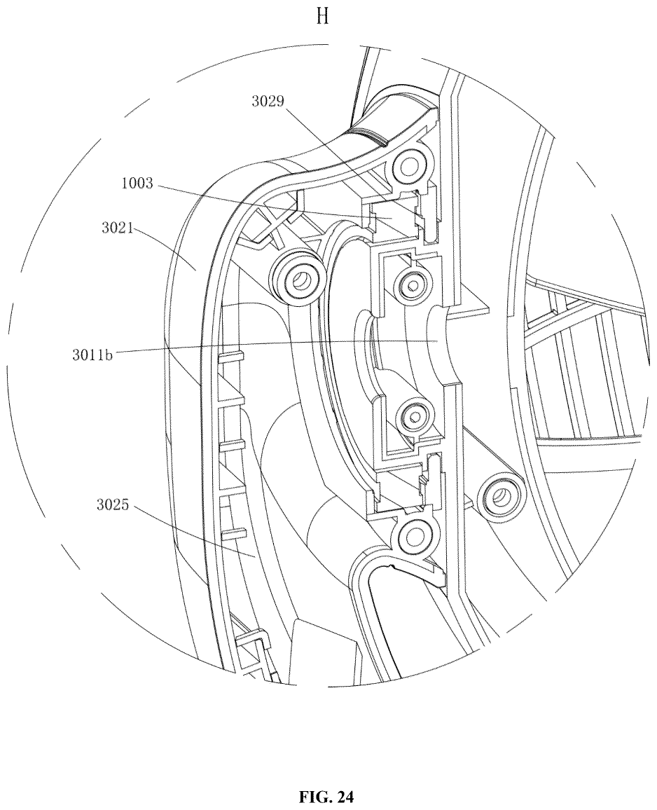

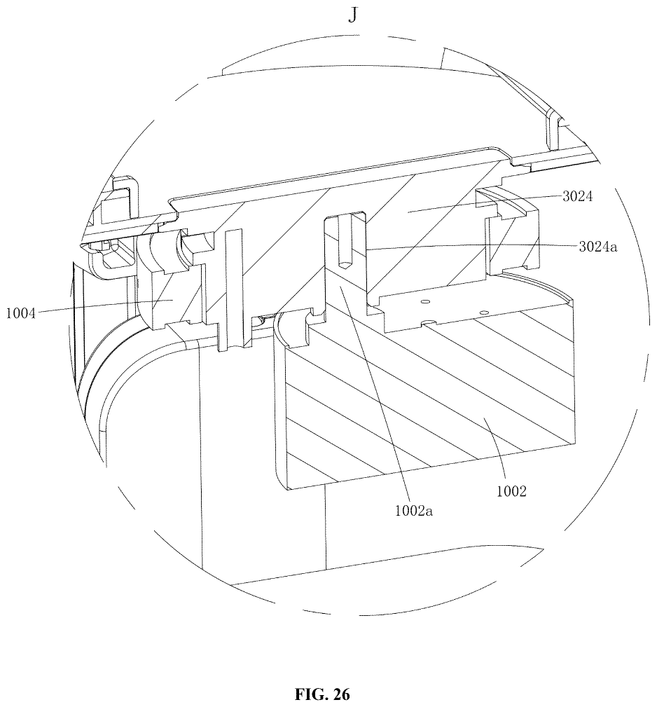

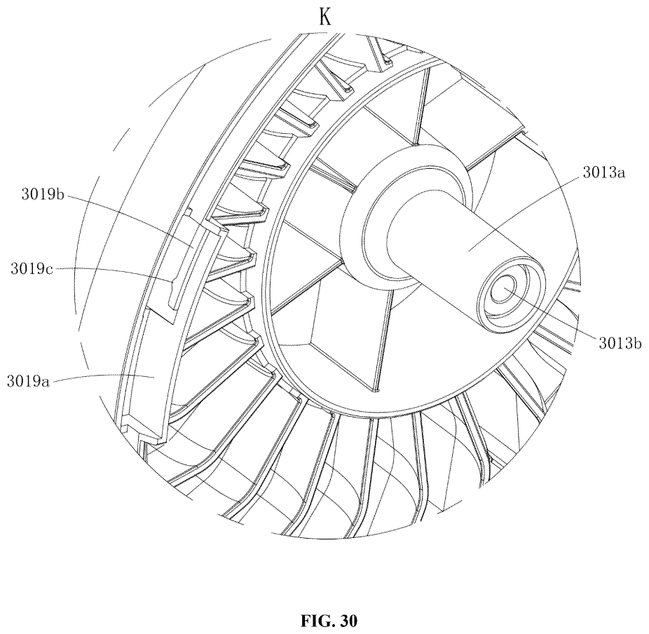

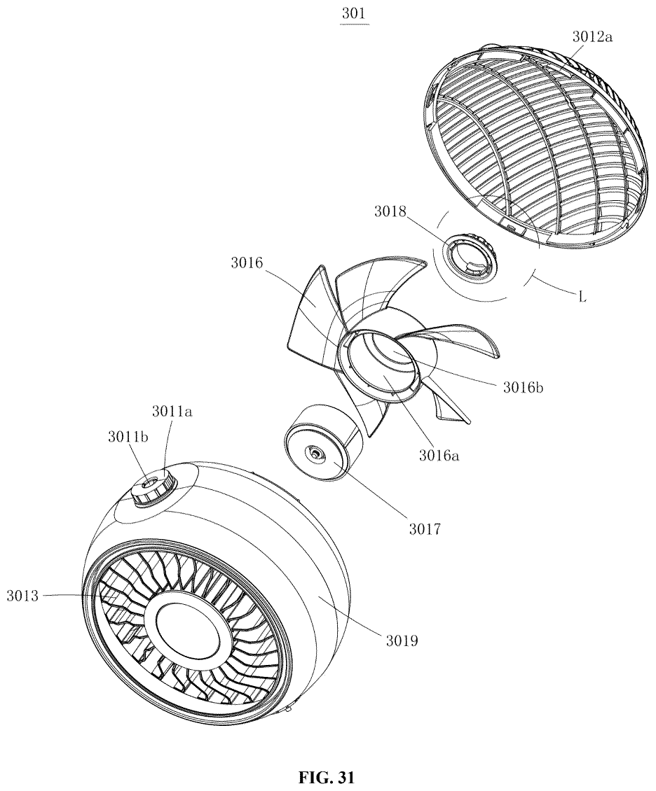

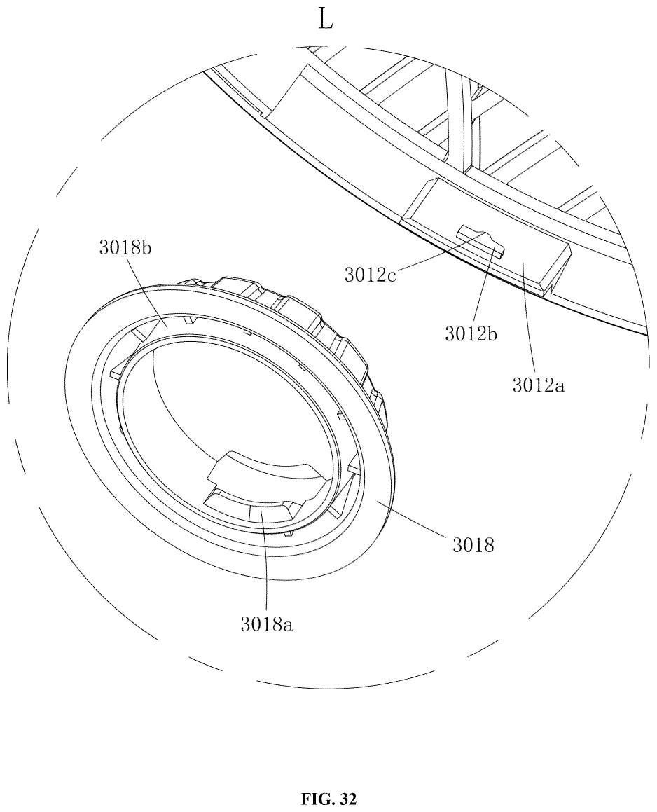

Please refer to FIGS. 18-34, a fan includes a fan body 100 and a bracket assembly 200, the fan body 100 is connected to the bracket assembly 200, and the bracket assembly 200 is used to support the fan body 100.

The fan body 100 of the fan includes a blower unit 300 for air blowing and a main unit 400 for controlling the blower unit 300.

The blower unit 300 includes a blowing component 301 and a support bracket 302. The blowing component 301 is used for blowing, and the support bracket 302 is rotatably connected to the blowing component 301, and supports the blowing component 301. The support bracket 302 is also rotatably connected to the main unit 400.

The fan body 100 further includes at least one first driving device 1001, and the main unit 400 is electrically connected to and drives the first driving device 1001. The first driving device 1001 is respectively connected to the blowing component 301 and the support bracket 302 to drive the blowing component 301 rotates relative to the support bracket 302.

It can be understood that the fan consists of the fan body 100 and the bracket assembly 200. The fan body 100 is set on the bracket assembly 200, and the bracket assembly 200 is placed on the ground or desktop to support the fan body 100. The fan body 100 includes an blower unit 300 and a main unit 400 for blowing air. The main unit 400 can control the start stop and blowing power of the blower unit 300. The blower unit 300 includes a blowing component 301 and a support bracket 302. The support bracket 302 and the blowing component 301 can rotate with each other to adjust the blowing angle of the blowing component 301. The first driving device 1001 is a brushless motor, and the first driving device 1001 is set between the support bracket 302 and the blowing component 301. The first driving device 1001 is respectively connected to the blowing component 301 and the support bracket 302, and is electrically connected to main unit 400, users can control the rotation of the first driving device 1001 through the main unit 400 to rotate the blowing component 301 relative to the support bracket 302, achieving the purpose of adjusting the blowing angle up and down. Traditional fans are directly connected by rotating the blowing component 301 and the support bracket 302, and users need to manually rotate the blowing component 301 to adjust the blowing angle. However, the fan provided by the present invention uses a motor to control the blowing angle adjustment, which is quieter, smoother, and more labor-saving, it does not require users to manually rotate and adjust, and also avoids the risk of being injured by the blade impeller when users reach out to adjust the blowing angle, improving the user experience.

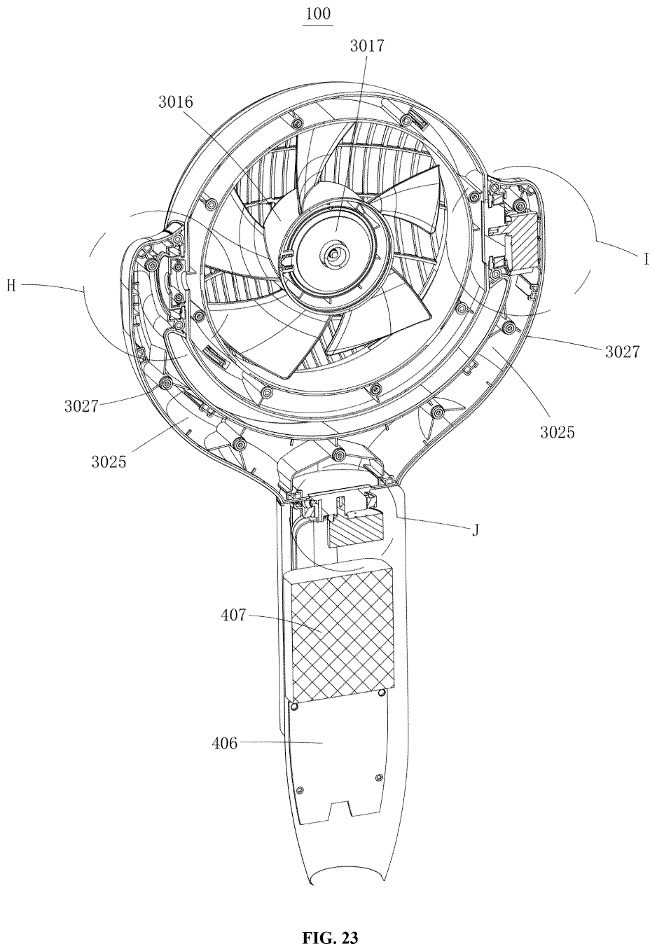

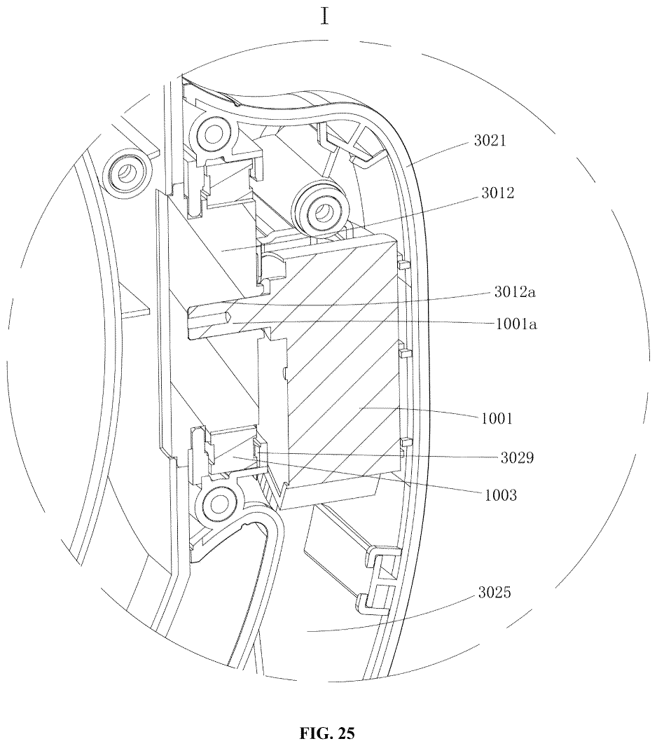

Please refer to FIGS. 23 and 25, in this embodiment, the fan body 100 further includes at least one second driving device 1002. The main unit 400 is electrically connected to the second driving device 1002 and drives the second driving device 1002. The second driving device 1002 is respectively connected to the support bracket 302 and the main unit 400 to drive the support bracket 302 rotates relative to the main unit 400. It can be understood that the second driving device 1002 is a brushless motor, which is connected to the support bracket 302 and the main unit 400 respectively. Users can control the rotation of the second driving device 1002 through the main unit 400 to make the support bracket 302 rotates relative to the main unit 400, achieving the purpose of adjusting the blowing angle left and right.

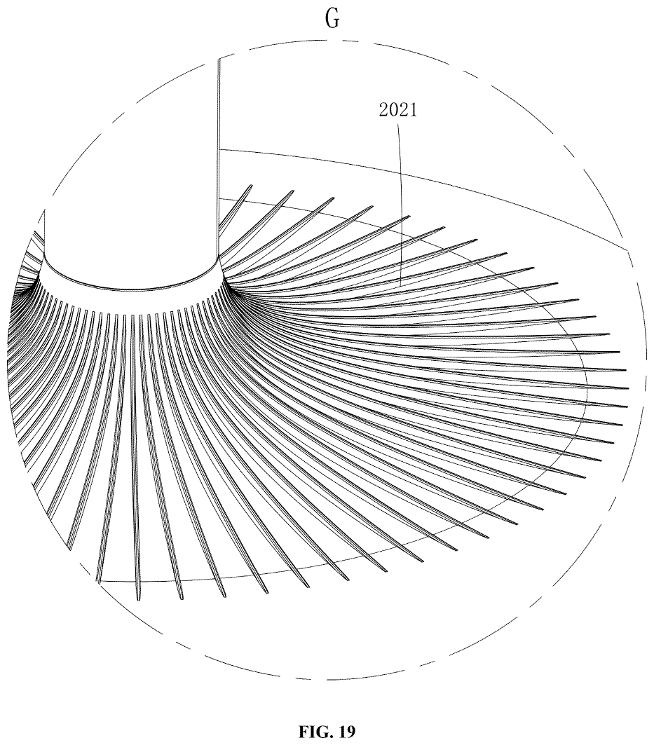

Please refer to FIGS. 19 and 23-25, in this embodiment, the blowing component 301 includes a first housing 3011, and a protruding first connecting shaft 3012 is provided on the outer side of the first housing 3011. The support bracket 302 includes at least one support arm 3027, which is used to connect the blowing component 301. The support bracket 302 includes a second housing 3021, and the second housing 3021 at the support arm 3027 is provided with a first shaft hole 3022, the first connecting shaft 3012 is arranged in the first shaft hole 3022.

That is, the support bracket 302 has at least one support arm 3027, and the blowing component 301 is rotatably connected to the support arm 3027; the first housing 3011 is located on the outermost side of the blowing component 301, and a first connecting shaft 3012 is provided in the first housing 3011 where it is connected to the support arm 3027. The second housing 3021 of the support arm 3027 is provided with a first shaft hole 3022, and the first connecting shaft 3012 is arranged in the first shaft hole 3022 to rotate and connect the blowing component 301. Specifically, this embodiment includes two support arms 3027, which are respectively connected to both sides of the blowing component 301; and each of the support arms 3027 is provided with one first shaft hole 3022.

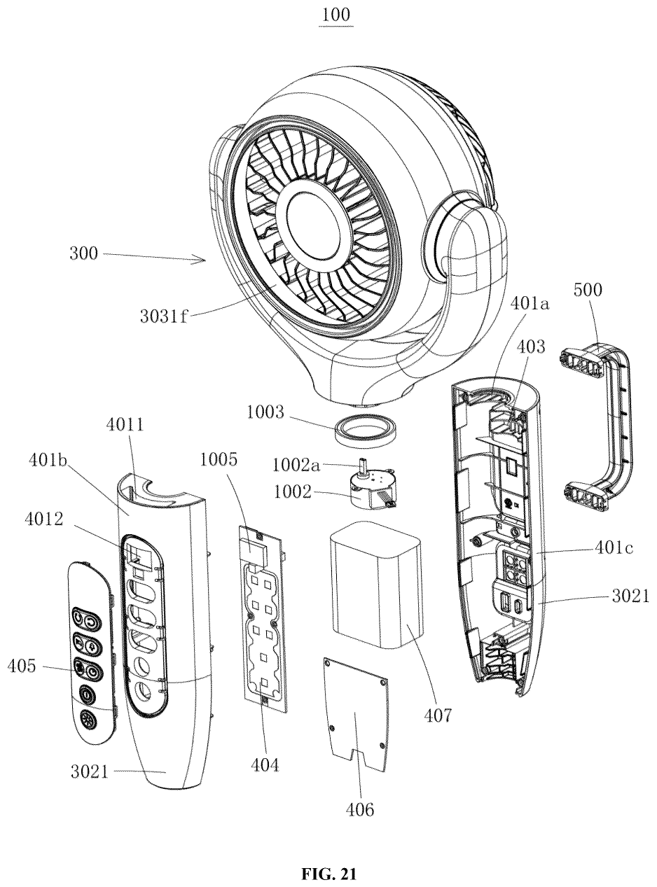

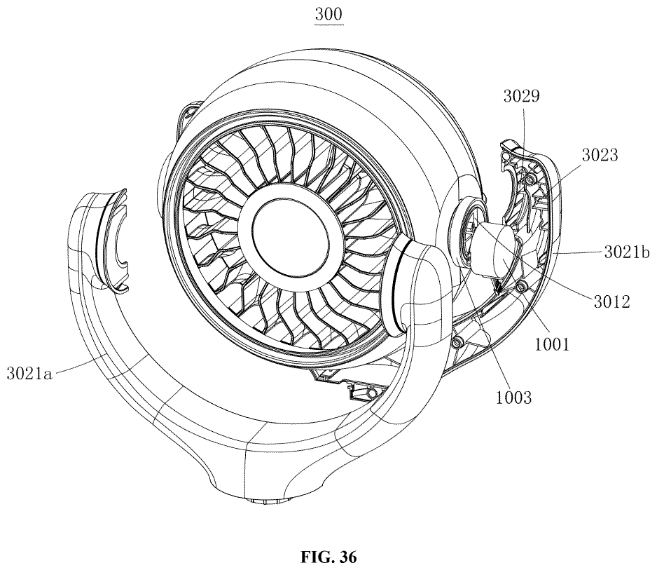

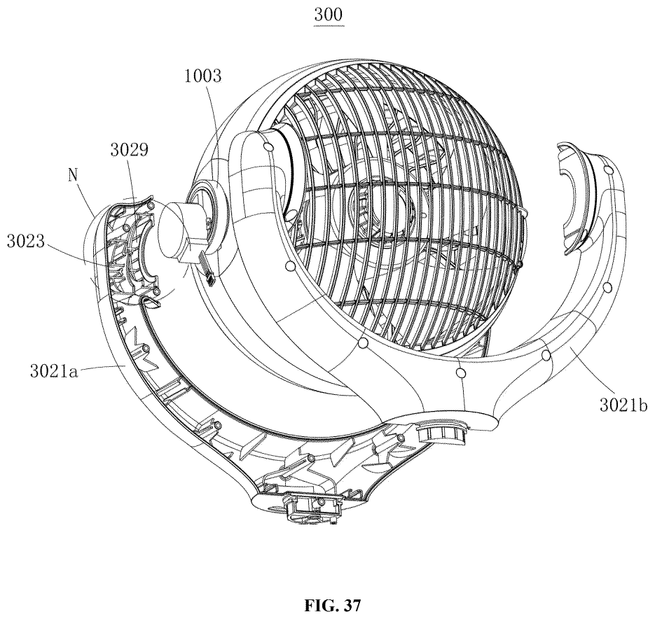

Please refer to FIGS. 21-23, 26, and 35-37, in this embodiment, the second housing 3021 includes a first shell 3021a and a second shell 3021b detachably connected to the first shell 3021a. The fan body 100 also includes a first bearing 1003, which is sleeved on the first connecting shaft 3012. The second housing 3021 is provided with a first bearing slot 3029, which is connected to the first shaft hole 3022. Part of the first bearing slot 3029 is located in the first shell 3021a, and a remaining part of the first bearing slot 3029 is located in second shell 3021b; part of the first shaft hole 3022 is located in the first shell 3021a, and a remaining part the first shaft hole 3022 is located in second shell 3021b.

It can be understood that the first bearing 1003 can make the rotation between the blowing component 301 and the support frame 302 smoother and quieter. Both support arms 3027 are equipped with first bearing slots 3029, and there are two first bearings 1003. The two first bearings 1003 are respectively set in the two first bearing slots 3029. Specifically, a portion of the first bearing slot 3029 is located on the first shell 3021a, while another portion of the first bearing slot 3029 is located on the second shell 3021b. During assembly, the first bearing 1003 is first placed in a portion of the first bearing slot 3029 on the first shell 3021a or the second shell 3021b, and then the second shell 3021b is assembled to the first shell 3021a through a plurality of poisoning pins and holes 3021c (pins can be in one of the first shell 3021a or second shell 3021b, and holes can be the other one of the first shell 3021a or second shell 3021b), or other locking members, so that a portion of the first bearing 1003 can also be placed in a portion of the first bearing slot 3029 on the second shell 3021b or the first shell 3021a. With the above structure, the first bearing 1003 can be placed in the first bearing slot 3029 through assembly and fitted onto the first connecting shaft 3012. The position of the first bearing 1003 remains unchanged after being placed in the first bearing slot 3029, i.e., the first bearing slot 3029 can prevent the first bearing 1003 from escaping from the first bearing slot 3029, which can ensure that the first bearing 1003 is always sleeved on the first connecting shaft 3012 and will not fall off, strengthening the stability of the structure. The first bearing 1003 can use common bearings which has an inner ring, an outer ring, and a plurality of ball bearings between the inner ring and the outer ring, the outer ring can be fixed by the first bearing slot 3029, and the inner ring can be rotatable relative to the outer ring due to the ball bearings.

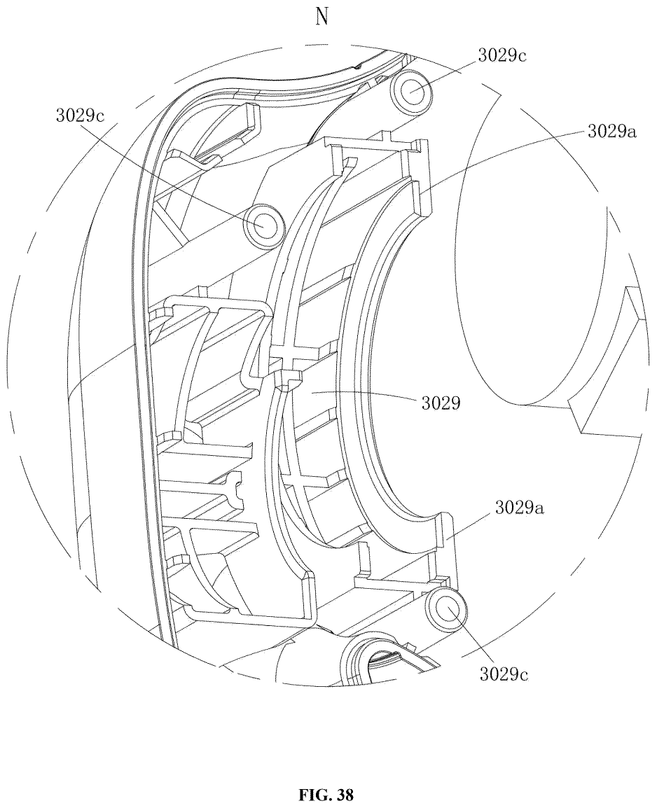

Please refer to FIG. 38, the first bearing slot 3029 is designed to interlock with two opposite portions on the diameter of the first bearing 1003. Additionally, the edge of the bearing groove 3029 features a fixing plate 3029a, which is used to limit the outer ring of the first bearing 1003.

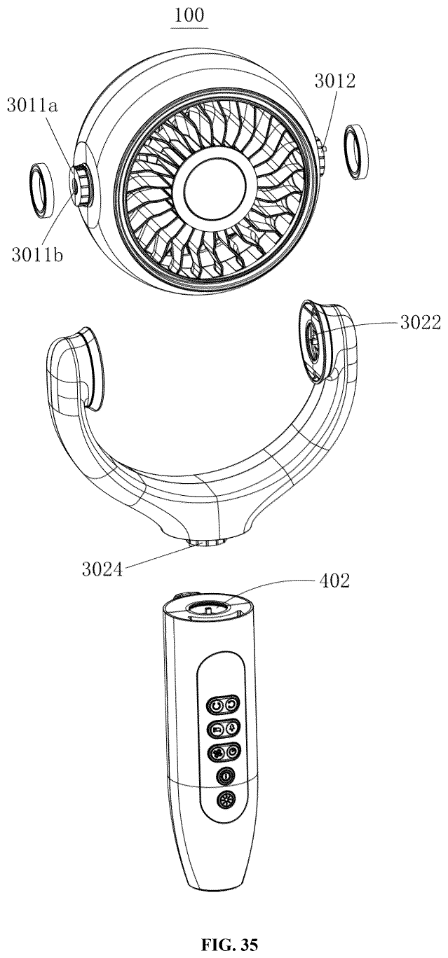

Please refer to FIG. 23, FIG. 25, and FIG. 35-37, in this embodiment, a first mounting slot 3023 is provided inside the second housing 3021, which is connected to the first shaft hole 3022. The first driving device 1001 is set in the first mounting slot 3023, so that the first driving device 1001 can be detachably connected to the support bracket 302. The first driving device 1001 is connected to the first connecting shaft 3012 to drive the blowing component 301 relative to the support bracket 302. It can be understood that the first mounting slot 3023 is connected to the first shaft hole 3022, and the first driving device 1001 is detachably arranged in the first mounting slot 3023 and connected to the first bearing 1003 arranged in the first shaft hole 3022 to drive the blowing component 301 to rotate. The first driving device 1001 is detachably located in the first mounting slot 3023, making it easy to install and remove.

Specifically, some of the first mounting slots 3023 are set on the first shell 3021a, and some of the first mounting slots 3023 are set on the second shell 3021b. During assembly, the first driving device 1001 is first placed in the first mounting slot 3023 on the first shell 3021a or the second shell 3021b, and then the second shell 3021b is connected to the first shell 3021a. A part of the first driving device 1001 can also be placed in the first mounting slot 3023 on the second shell 3021b or the first shell 3021a, so that the first driving device 1001 can be completely set in the first mounting slot 3023, which is convenient for assembly.

Please refer to FIGS. 23 and 25, in this embodiment, the first driving device 1001 includes a first rotating shaft 1001a, and a first insertion hole 3012a is provided on the first connecting shaft 3012, the first rotating shaft 1001a is inserted into the first insertion hole 3012a. It can be understood that the first rotating shaft 1001a is inserted into the first insertion hole 3012a. When the first rotating shaft 1001a rotates, it drives the first connecting shaft 3012 to rotate, thereby driving the blowing component 301 to rotate up and down.

Please refer to FIGS. 18, 21-23, 26, and 35, in this embodiment, the support bracket 302 includes the second housing 3021, which is rotatably connected to the main unit 400. The support bracket 302 is equipped with a protruding second connecting shaft 3024 at a bottom of the support bracket 302 near the main unit 400. The main unit 400 includes a third housing 401, which is provided with a second shaft hole 402. The second connecting shaft 3024 is arranged in the second shaft hole 402. This can be understood that the second housing 3021 is provided with a protruding second connecting shaft 3024, and the main unit 400 includes a third housing 401; the second connecting shaft 3024 is set in the third housing 401 and has a second shaft hole 402, which allows the blowing component 301 to rotate and connect with the main unit 400, thereby adjusting the blowing angle of the blowing component 301 in the left and right directions.

Please refer to FIGS. 21-23 and 26, in this embodiment, the fan body 100 further includes a second bearing 1004, which is sleeved on the second connecting shaft 3024. The third housing 401 is provided with a second bearing slot 401a, which is connected to the second shaft hole 402; The third housing 401 is composed of a third shell 401b and a fourth shell 401c detachably connected together. Part of the second bearing slot 401a is provided in the third shell 401b, and part of the second bearing slot 401a is provided in the fourth shell 401c. It can be understood that the second bearing 1004 can make the rotation between the blowing component 301 and the main unit 400 smoother and quieter.

Specifically, a portion of the second bearing slot 401a is located on the third shell 401b, while another portion of the second bearing slot 401a is located on the fourth shell 401c. During assembly, the second bearing 1004 is first placed in the portion of the second bearing slot 401a on the third shell 401b or the fourth shell 401c, and then the third shell 401b is connected to the fourth shell 401c, so that a portion of the second bearing 1004 can also be placed in the portion of the second bearing slot 401a on the fourth shell 401c or the third shell 401b. With the above structure, the second bearing 1004 can be placed in the second bearing slot 401a through assembly and fitted onto the second connecting shaft 3024, and after the second bearing 1004 is placed in the second bearing slot 401a, and its position remains unchanged. This ensures that the second bearing 1004 is always fitted onto the second connecting shaft 3024 without falling off, thereby enhancing the stability of the structure.

Please refer to FIGS. 21-22 and 35, in this embodiment, a second mounting slot 403 is provided inside the third housing 401, which is connected to the second shaft hole 402. The second driving device 1002 is set in the second mounting slot 403 to allow for a detachable connection between the second driving device 1002 and the main unit 400. The second mounting slot 403 is connected to the second connecting shaft 3024 to drive the support bracket 302 relative to the main unit 400. It can be understood that the second mounting slot 403 is connected to the second shaft hole 402. The second driving device 1002 is detachably installed in the second mounting slot 403 and connected to the second bearing 1004 installed in the second shaft hole 402 to drive the blowing component 301 to rotate. The second driving device 1002 is detachable and located in the first mounting slot 3023, making it easy to install and remove.

Specifically, some of the second mounting slots 403 are set on the third shell 401b, and some of the second mounting slots 403 are set on the fourth shell 401c. When assembling, first place the second driving device 1002 in the second mounting slot 403 on the third shell 401b or the fourth shell 401c, and then connect the third shell 401b and the fourth shell 401c together. A part of the second driving device 1002 can also be placed in the second mounting slot 403 on the third shell 401b or the fourth shell 401c, so that the second driving device 1002 can be completely set in the second mounting slot 403 for easy assembly.

Please refer to FIGS. 21-23 and 26, in this embodiment, the second driving device 1002 includes a second rotating shaft 1002a, and a second insertion hole 3024a is provided on the second connecting shaft 3024. The second rotating shaft 1002a is inserted into the second insertion hole 3024a. It can be understood that the second rotating shaft 1002a is inserted into the second insertion hole 3024a. When the second rotating shaft 1002a rotates, it drives the second connecting shaft 3024 to rotate, thereby driving the blowing component 301 to rotate left and right.

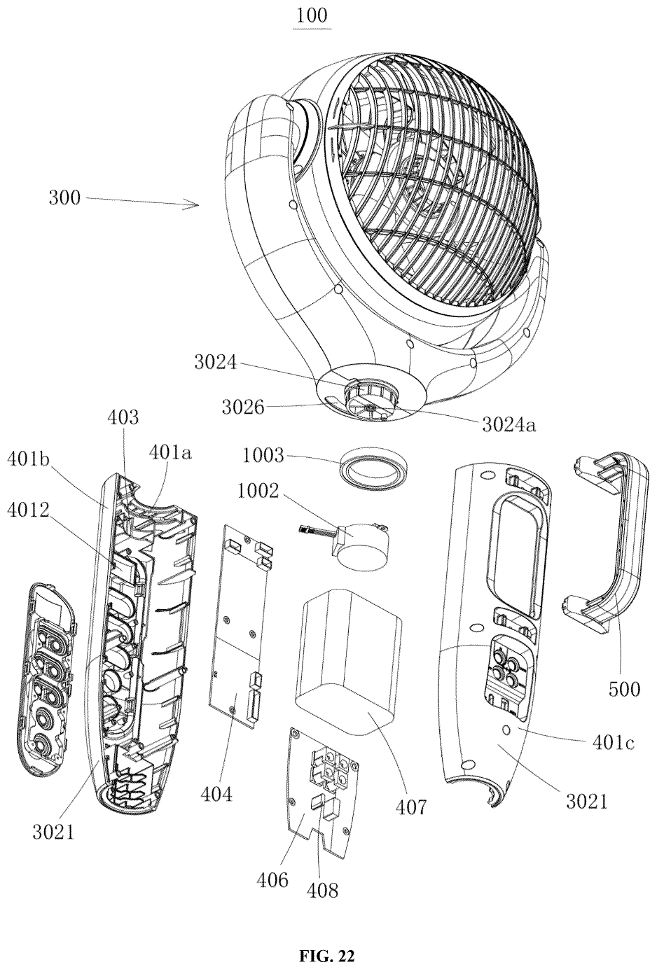

Please refer to FIGS. 22-25, 28, and 34, in this embodiment, a wiring channel 3025 is formed around an inner wall of the second housing 3021. The wiring channel 3025 is connected to the first mounting slot 3023 and the first shaft hole 3022. The bottom of the second housing 3021 is provided with a first wire hole 3026, which is connected to the wiring channel 3025; external wires are threaded through the wiring channel 3025, the first wire hole 3026, and connected to the first driving device 1001 and the main unit 400, so as to electrically connect the first driving device 1001 and the main unit 400. It can be understood that the wiring channel 3025 is set inside the support bracket 302 and extends from the support arm 3027 to the bottom of the support bracket 302 close to the main unit 400. The second housing 3021 at the bottom of the support bracket 302 is provided with a first wire hole 3026, and external wires can be threaded through the first shaft hole 3022 and the first mounting slot 3023, and then pass through the wiring channel 3025 and exit from the first wire hole 3026 to be electrically connected to the main unit 400; the first driving device 1001 in the first mounting slot 3023 is connected to an external wire. The external wire passes through the wiring channel 3025 and exits the first wire hole 3026 before being electrically connected to the main unit 400, allowing the main unit 400 to control the first driving device 1001. The wiring channel 3025 can hide the wires inside without exposing them, increasing aesthetics, and the second shell 3021 outside the wiring channel 3025 can protect the wires from damage. Specifically, wiring channels 3025 are provided inside both support arms 3027.

Please refer to FIG. 21, in this embodiment, the main unit 400 includes a third housing 401, which is provided with a second wire hole 4011. The second wire hole 4011 is connected to the first wire hole 3026. The main unit 400 also includes a control motherboard 404 and control buttons 405. The control buttons 405 are arranged on the third housing 401, and the control motherboard 404 is arranged inside the third housing 401 and electrically connected to the control buttons 405. External wires are extend through the wiring channel 3025, the first wire hole 3026, the second wire hole 4011, and connected to the first driving device 1001 and the control motherboard 404, so that the first driving device 1001 is electrically connected to the control motherboard 404.

It can be understood that the third housing 401 of the main unit 400 is provided with the second wire hole 4011, which is connected to the first wire hole 3026, so that wires can pass through the first wire hole 3026 and electrically connect to the control motherboard 404 inside the main unit 400 through the second wire hole 4011. The first wire hole 3026 and the second wire hole 4011 both have a certain width. When the blowing component 301 swings left and right, the second housing 3021 and the third housing 401 will rotate relative to each other. The wires passed through the first wire hole 3026 and the second wire hole 4011 will not be pinched by the second housing 3021 and the third housing 401 when they rotate relative to each other, and the wires will not be exposed, which increases aesthetics and also protects the device, and the wire is not damaged. The control button 405 is located on the third housing 401 and is electrically connected to the control motherboard 404, users can control the start/stop and power of the blowing component 301 by pressing the control button 405, as well as control the rotation of the first driving device 1001 and the second driving device 1002 to rotate the blowing component 301 in the up, down, left, and right directions and adjust the blowing angle.

Please refer to FIGS. 21-22, in this embodiment, the main unit 400 further includes a circuit board 406, a battery 407, and a charging interface 408. The circuit board 406 and the battery 407 are arranged inside the third housing 401, and the charging interface 408 is arranged on the third housing 401. The charging interface 408 is electrically connected to the circuit board 406, and the battery 407 is electrically connected to the circuit board 406 and the control motherboard 404, respectively. It can be understood that the charging interface 408 can be a commonly used interface such as USB, Type-C, etc. The circuit board 406 stabilizes the current charged by the charging interface 408 and converts it into an appropriate current to charge the battery 407. The battery 407 can store electrical energy, allowing the fan to work even when not plugged in.

Please refer to FIG. 21, in this embodiment, the fan body 100 includes a sensing device 1005, which is electrically connected to the main unit 400. When the sensing device 1005 detects the proximity of a human body, it sends an electrical signal to the main unit 400, which controls the blowing component 301 to blow automatically. It can be understood that the sensing device 1005 is set on the fan. The sensing device 1005 is an infrared sensing device, and the human body emits infrared radiation. When the user approaches the fan to a certain distance, the sensing device 1005 detects the infrared radiation of the human body and sends an electrical signal to the main unit 400. The main unit 400 will activate the blowing component 301 to blow air, so that when the human body approaches the fan, the fan will automatically start blowing air. Specifically, the sensing device 1005 is installed on the main unit 400 and electrically connected to it. The sensing device 1005 is located on the front of the main unit 400, facing the user's direction, to facilitate the detection of the user's infrared radiation.

Please refer to FIG. 21, in this embodiment, the main unit 400 includes a control motherboard 404, which is electrically connected to the blowing component 301 to control the blowing component 301. The sensing device 1005 is set on the control motherboard 404 and is electrically connected to the control motherboard 404. The main unit 400 includes a third housing 401, which is provided with a hole 4012. The sensing device 1005 is configured in the hole 4012 and partially exposed, this can be understood that the sensing device 1005 is configured in the hole 4012 opened in the third housing 401, and partially exposed from the hole 4012, which can increase the detection range of the sensing device 1005. The sensing device 1005 is installed on the control motherboard 404 and is electrically connected to the control motherboard 404. When the sensing device 1005 detects the user's approach, it will send an electrical signal to the control motherboard 404. The control motherboard 404 will power on the blowing component 301 to start, causing it to blow air.

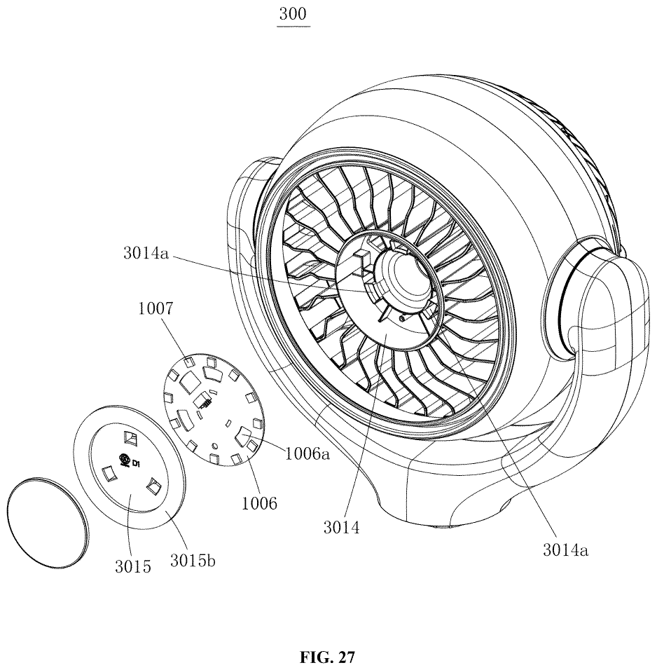

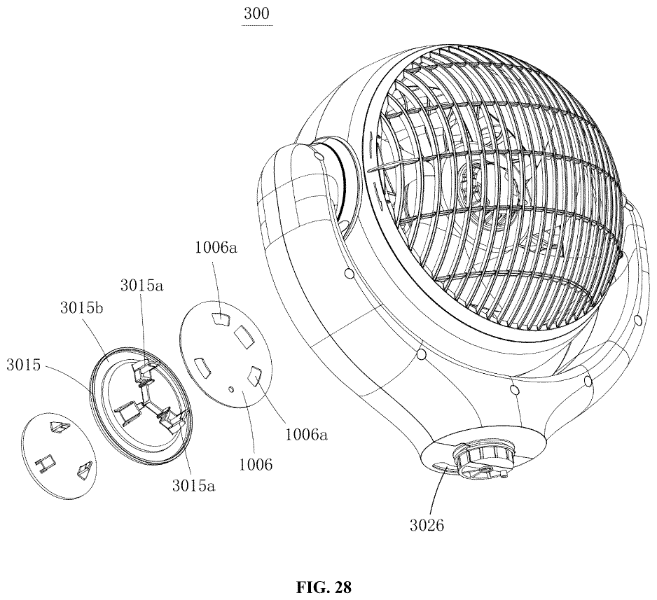

Please refer to FIGS. 27-28, in this embodiment, the fan body 100 further includes a light emitting device 1006 that can emit light. The light emitting device 1006 is set on the blowing component 301 and is electrically connected to the main unit 400. The main unit 400 is used to control the start and stop of the light emitting device 1006. It can be understood that the light emitting device 1006 can emit multiple colors of light and various light effects (such as breathing, continuous brightness, flowing light, etc.), providing users with a better visual experience when using the fan, users can use the control button 405 on the main unit 400 to control the start/stop and switch multiple light effects of the light emitting device 1006.

Please refer to FIGS. 27-28, in this embodiment, the first housing 3011 includes an air inlet hood 3012d and an air outlet hood 3013, which are connected; a third mounting slot 3014 is provided at a central position of the air outlet hood 3013, and the light emitting device 1006 is arranged in the third mounting slot 3014. It can be understood that the light emitting device 1006 is located in a middle position of the air outlet cover 3013, so that the light emitting device 1006 can face the user. Specifically, the blowing component 301 also includes a fixing cover 3015, which is used to cover the light emitting device 1006. The third mounting slot 3014 is provided with a first slot 3014a, and the light emitting device 1006 is provided with a second slot 1006a corresponding to the position of the first slot 3014a. The fixing cover 3015 is provided with a first plug 3015a, which is inserted into the second slot 1006a and the first slot 3014a to fix the light emitting device 1006 in the third mounting slot 3014, so that the light emitting device 1006 can be more stably fixed in the third mounting slot 3014. Preferably, the light emitting device 1006 includes multiple LED beads 1007 arranged in a circle, and the fixing cover 3015 includes a translucent lampshade 3015b, which is arranged around the edge of the fixing cover 3015, the position of the lampshade 3015b corresponds to the position of the LED beads 1007, this can be understood that the light emitted by the light emitting device 1006 is circular, and the position of the lampshade 3015b corresponds to the position of the LED beads 1007, allowing the light emitted by the light emitting device 1006 to pass through the lampshade 3015b and shine outward.

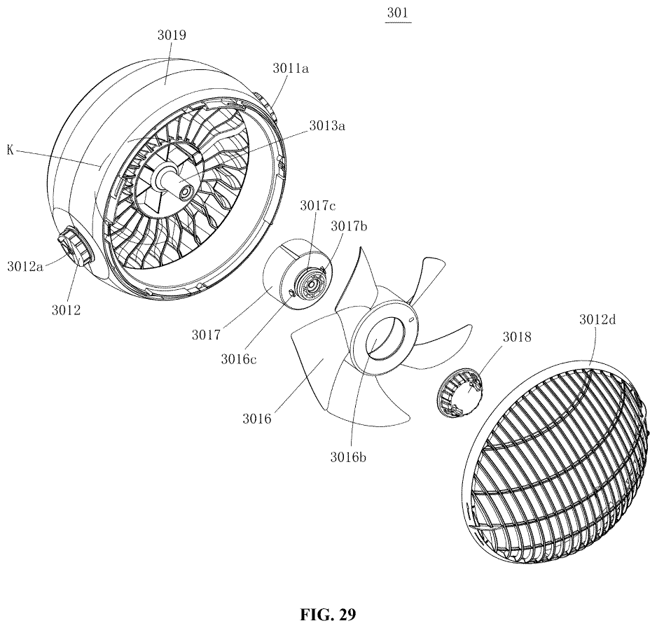

Please refer to FIGS. 29-32, in this embodiment, the blowing component 301 includes a third driving device 3017 and a blade impeller 3016, and the third driving device 3017 and the blade impeller 3016 are arranged inside the first housing 3011, and has an impeller body in the center and a plurality of blades extending from the impeller body, and the blade impeller 3016 is detachably connected to the third driving device 3017. The third driving device 3017 is electrically connected to the main unit 400 to drive the blade impeller 3016 to rotate. The blade impeller 3016 is provided with a fourth mounting slot 3016a, and the third driving device 3017 is detachably arranged in the fourth mounting slot 3016a, so that the blade impeller 3016 and the third driving device 3017 can be detachably connected.

It can be understood that the third driving device 3017 is a brushless motor. The third driving device 3017 is used to drive the rotation of the blade impeller 3016, and the third driving device 3017 is detachable and can be installed in the fourth mounting slot 3016a for easy disassembly. The blade impeller 3016 is detachably connected to the third driving device 3017 for easy replacement and installation of the blade impeller 3016. Specifically, a fourth connecting shaft 3013a is provided on one side of the air outlet hood 3013, and a third insertion hole 3013b is opened on the fourth connecting shaft 3013a. The third driving device 3017 includes a third rotating shaft 3017a, which is inserted into the third insertion hole 3013b to allow the third driving device 3017 to be detachably connected to the air outlet hood 3013. It can be understood that the third connecting shaft 3011a is set on the inner side of the air outlet cover 3013, the third insertion hole 3013b is set on the axis of the third connecting shaft 3011a, and the third rotating shaft 3017a of the third driving device 3017 is inserted into the third insertion hole 3013b to allow the third driving device 3017 to be detachably connected to the air outlet cover 3013.

Please refer to FIGS. 29-32, in this embodiment, a through hole 3016b is provided in the center of the impeller body of the blade impeller 3016, and a diameter of the through hole 3016b is smaller than that of the third driving device 3017. The through hole 3016b is connected to the fourth mounting slot 3016a, and a first connecting part 3017b is provided on the side of the third driving device 3017 opposite to the third rotating shaft 3017a. The first connecting part 3017b is passed through the through hole 3016b. The blowing component 301 also includes a fixing part 3018, which is used to connect with the first connecting part 3017b and abut against the side wall around the through hole 3016b, so that the blade impeller 3016 and the third driving device 3017 are fixedly connected.

It can be understood that a diameter of the through hole 3016b is smaller than that of the third driving device 3017, which can keep the third driving device 3017 in the fourth mounting slot 3016a and prevent it from falling off from the through hole 3016b. The first connecting part 3017b penetrates through the through hole 3016b, and a diameter of the fixing part 3018 is larger than that of the through hole 3016b. After connecting the fixing part 3018 with the first connecting part 3017b, it is pressed against the side wall around the through hole 3016b, so that the blade impeller 3016 is fixedly connected to the third driving device 3017. After removing the fixing part 3018 from the first connecting part 3017b, the blade impeller 3016 can be removed from the third driving device 3017. Specifically, the first connecting part 3017b is provided with a first thread 3017c, and the inner wall of the fixing part 3018 is provided with a slider 3018a that cooperates with the thread 3017c. The slider 3018a slides on the thread 3017c to allow the fixing part 3018 to be rotatably connected to the first connecting part 3017b. It can be understood that rotating the fixing part 3018 causes the slider 3018a to slide on the thread 3017c. The fixing part 3018 will approach the blade impeller 3016 until the fixing part 3018 contacts an outer wall of the blade impeller 3016, at this point, the fixing part 3018 locks the blade impeller 3016 with the third driving device 3017. Turning the fixing part 3018 in the opposite direction will cause the fixing part 3018 to move away from the blade impeller 3016 until the slider 3018a completely disengages from the thread 3017c, at this point, the blade impeller 3016 can be removed from the third driving device using a threaded connection method, which is convenient to use, reliable, and not easily damaged.

Preferably, the outer wall of the third driving device 3017 is provided with a positioning member 3016c, which is configured to pass through the through hole 3016b. The fixing part 3018 is provided with an annular groove 3018b, which is arranged along the circumferential direction. When the fixing part 3018 is rotatably connected to the first connecting part 3017b, the positioning member 3016c slides in the annular groove 3018b. It can be understood that the positioning piece 3016c slides in the annular groove 3018b, which can keep the fixing piece 3018 rotating in the correct position without tilting. When the user installs or disassembles the fixing piece 3018, the fixing piece 3018 rotates more smoothly and stably, improving the user experience.

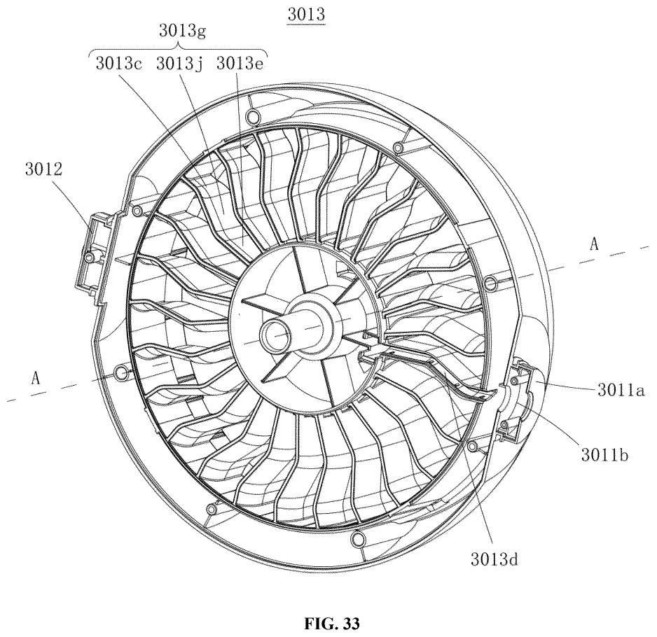

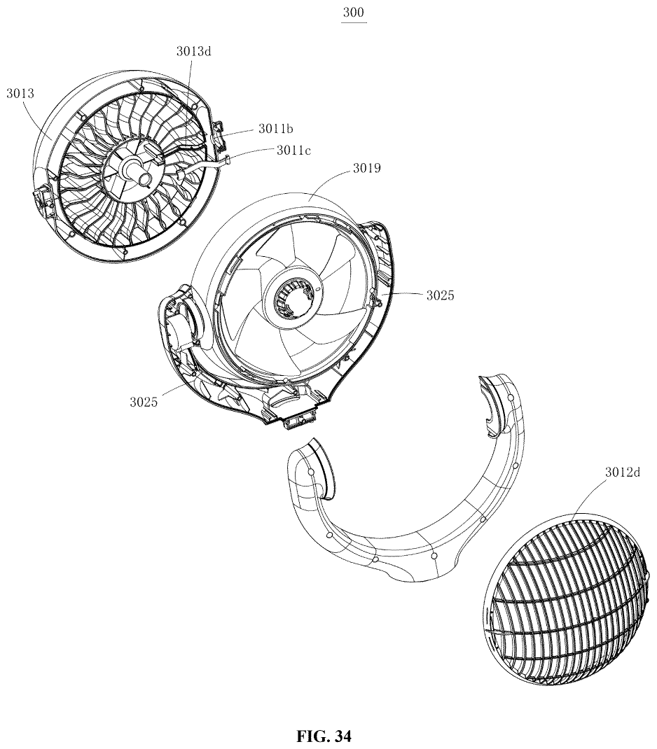

Please refer to FIGS. 33-34, in this embodiment, a protruding third connecting shaft 3011a is provided on an outer side of the first housing 3011. The third connecting shaft 3011a is rotatably connected to the support bracket 302, and a third wire hole 3011b is opened on the third connecting shaft 3011a. A wire slot 3013d is opened on the side of the air outlet cover 3013 facing the blade impeller 3016, one end of the wire slot 3013d is connected to the fourth mounting slot 3016a, and the other end of the wire slot 3013d is connected to the third wire hole 3011b. It can be understood that the third connecting shaft 3011a is opposite to the first connecting shaft 3012 and is respectively set on both sides of the blowing component 301. The first connecting shaft 3012 and the third connecting shaft 3011a are respectively rotatably set on the side of the blowing component 301. In the two first shaft holes 3022 of the support arm 3027, the blowing component 301 is rotatably connected to the support bracket 302. The wire slot 3013d is oriented towards the blade impeller 3016, and cannot be seen from the outside, making the wire slot 3013d more concealed and increasing its aesthetic appeal. Specifically, one end of the wire slot 3013d is connected to the fourth mounting slot 3016a, and the other end of the wire slot 3013d is connected to the third wire hole 3011b. The wire is set in the wire slot 3013d, with one end connected to the third driving device 3017 and the other end passing through the third wire hole 3011b, after passing through a wiring channel 3025 in the support arm 3027, the wire passes through the first wire hole 3026 of the bottom of the second housing 3021 and is electrically connected to the main unit 400, so that the main unit 400 can control the start stop and rotation power of the third driving device 3017.

Please refer to FIGS. 33-34, in this embodiment, the blowing component 301 further includes a cover plate 3011c, which is used to cover the wire slot 3013d. It can be understood that after the cover plate 3011c is covered on the wire slot 3013d, it can protect the wires inside the wire slot 3013d.

Please refer to FIG. 33, in this embodiment, the blade impeller 3016 rotates to draw in air from the air inlet hood 3012d, forming an airflow that is then blown out from the air outlet hood 3013; the air outlet hood 3013 includes multiple air guide plates 3013g arranged in a circular pattern. The air guide plates 3013g are used to gather the airflow and blow it out along the rotation axis A-A direction of the blade impeller 3016; and the air guide plate 3013g includes a first section 3013c, a second section 3013j, and a third section 3013e, connected in sequence with a certain degree of bending between adjacent sections, each section has a certain length and width, and the width direction is parallel to the rotation axis A-A direction of the blade impeller 3016, this is used to guide the airflow direction to be parallel to the rotation axis A-A direction of the impeller 3016. It can be understood that the angle range of the bend between adjacent sections is 120 degrees to 150 degrees, when the impeller 3016 rotates, it sucks in air from the air inlet hood 3012d and generates an airflow that blows towards the air outlet hood 3013. Through the multi-stage design of the bending air guide plate 3013g, the fan can evenly blow the air forward, making the airflow more concentrated, improving the fan's blowing power, and enhancing the blowing efficiency.

It can be understood that there is a certain angle between the width direction of the first plate 3013b and the width direction of the second plate 3013c, with an angle range of 120-150 degrees. When the blade impeller 3016 rotates, it sucks in air from the air inlet hood 3012d and produces an airflow, which is blown towards the air outlet hood 3013. Firstly, blowing on the second plate 3013c, the airflow is guided by the second plate 3013c and blown towards the first plate 3013b. The width direction of the first plate 3013b is parallel to the axis A-A direction of the blade impeller 3016 rotation, so the first plate 3013b Guiding the direction of the airflow to be parallel to the axis A-A of the blade impeller 3016 rotation, through the above structural setting, the wind blown by the fan can be directed straight ahead, making the airflow more concentrated, improving the wind power of the fan, and enhancing the efficiency of blowing.

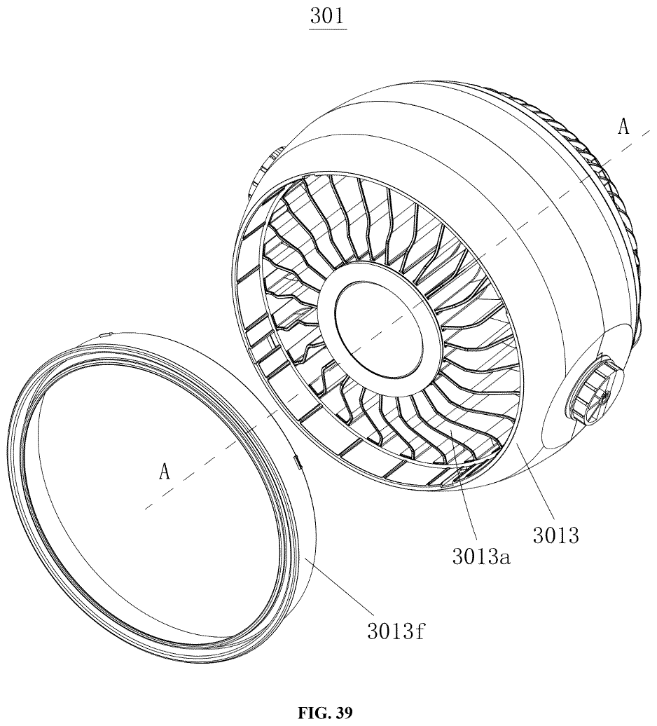

Please refer to FIG. 21 and FIGS. 38-39, in this embodiment, the air outlet hood 3013 further includes an air gathering ring 3013f, which is arranged around the air outlet side of the air outlet hood 3013. A diameter of the air gathering ring 3013f on the side away from the air outlet hood 3013 is smaller than a diameter of the air gathering ring 3013f on the side connected to the air outlet hood 3013, so that the airflow blown out through the air outlet hood 3013 is guided and converged by the air outlet hood 3013. It can be understood that the diameter of the air gathering ring 3013f on the side away from the air outlet cover 3013 is relatively smaller, after the airflow blown out through the air outlet cover 3013 is directed towards the axis A-A direction of the blade impeller 3016 rotation, the airflow is more concentrated, and the wind force of the fan outlet is greater.

Please refer to FIGS. 29-32, in this embodiment, the blowing component 301 includes a middle shell 3019, which is detachably connected to the air inlet hood 3012d and the air outlet hood 3013, respectively. The middle shell 3019 includes a first sliding groove 3019a, and a second plug 3012a is provided on the air inlet cover 3012d, which slides in the first sliding groove 3019a. The first sliding groove 3019a is provided with a first sliding strip 3019b, which is provided with a first convex portion 3019c. The second plug 3012a is provided with a second sliding strip 3012b, which is provided with a second convex portion 3012c. The second plug 3012a slides in the first sliding groove 3019a, causing the first sliding strip 3019b and the second sliding strip 3012b to come into contact and slide against each other until the first convex portion 3019c and the second convex portion 3012c are pressed against each other, and the first sliding strip 3019b and the second sliding strip 3012b are locked to each other.

It can be understood that the air intake hood 3012d is detachably connected to the middle shell 3019, which makes it convenient for users to disassemble and install the air intake hood 3012d. For example, when dust needs to be cleaned, the air intake hood 3012d can be easily removed to clean the interior. The second plug 3012a is inserted into the first sliding groove 3019a, and the air inlet cover 3012d is rotated to engage the first sliding strip 3019b with the second sliding strip 3012b, continuing to rotate the air inlet cover 3012d causes the first convex part 3019c and the second convex part 3012c to press against each other, in this way, the air inlet cover 3012d and the middle shell 3019 are installed and locked to each other. Rotate the air intake hood 3012d in the opposite direction, causing the first convex part 3019c and the second convex part 3012c to slide over each other, and the first sliding strip 3019b and the second sliding strip 3012b are separated, in order to remove the air intake hood 3012d.

Please refer to FIGS. 18-19, in this embodiment, the bracket assembly 200 includes a support rod 201 and a base 202, one end of the support rod 201 is connected to the main unit 400, and the other end of the support rod 201 is connected to the base 202. The base 202 is used to support the fan body 100; multiple reinforcing ribs 2021 are arranged on the base 202 in a circular pattern. It can be understood that multiple reinforcing ribs 2021 are arranged in a circular pattern, which can increase the strength of the base 202 and make the fan stand more stably after the base 202 is placed on the ground.

Please refer to FIGS. 18-19, in this embodiment, the fan further includes a handle 500, which is mounted on the main unit 400. It can be understood that users can use the handle 500 to transport the fan, providing convenience for their use.

### Embodiment 4

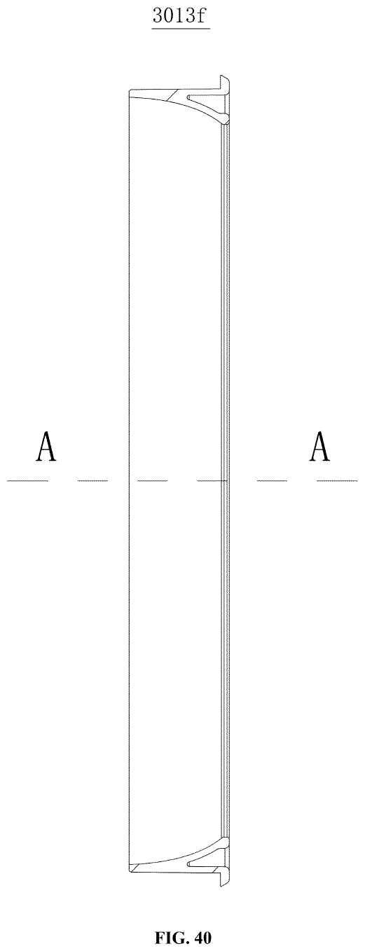

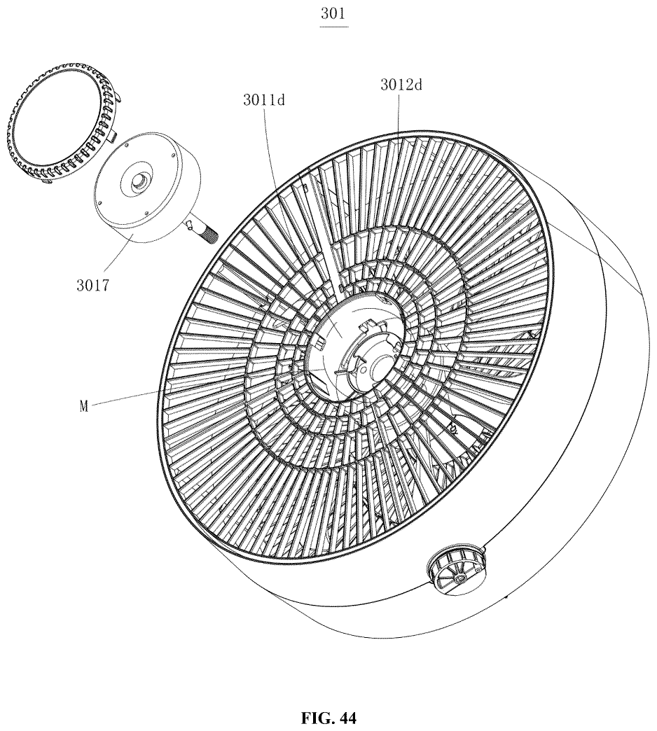

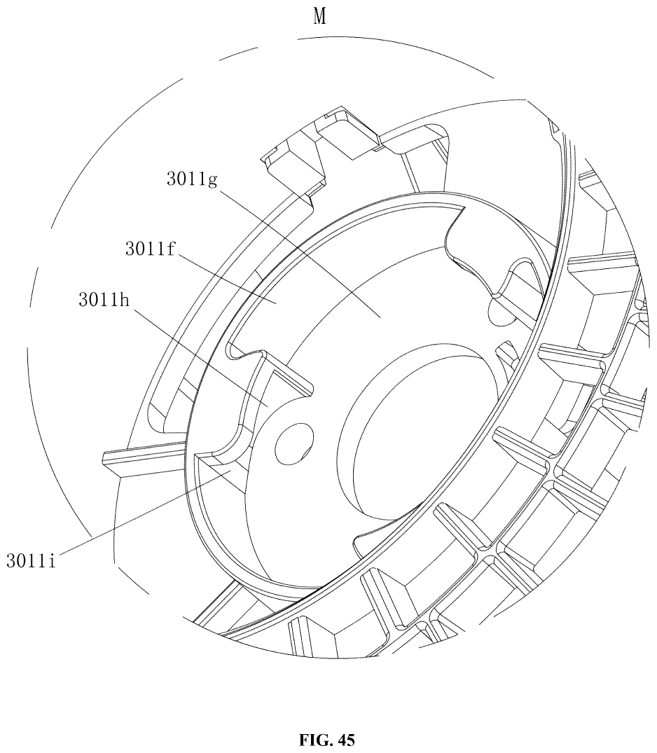

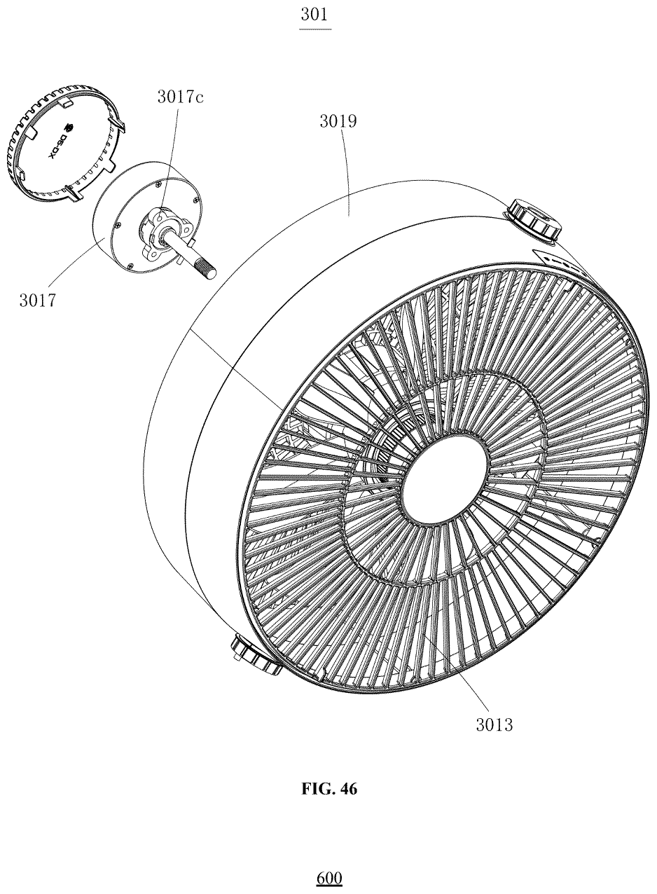

Please refer to FIGS. 40-46, compared with Example 3, this embodiment does not have a battery 407 and a light emitting device 1006. The wire slot 3013d is located on the side of the air inlet cover 3012d facing the blade impeller 3016. The third driving device 3017 is installed on the air inlet hood 3012d. Other structures are the same as Example 3 and will not be repeated here. This embodiment eliminates the battery 407 and the light emitting device 1006, which not only reduces the weight of the fan and production costs, but also lowers the selling price of the product, meeting the needs of more consumers' choices.

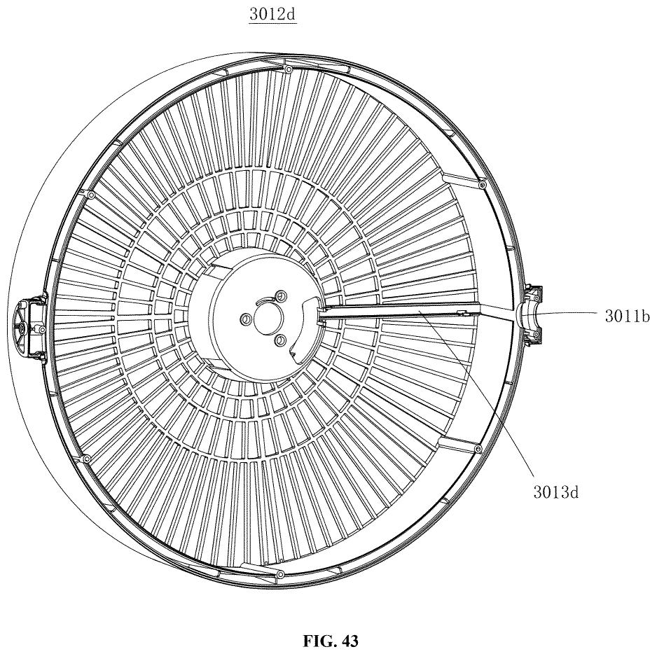

Please refer to FIGS. 43-46, in this embodiment, the outer wall of the first housing 3011 is inwardly recessed to form a fifth mounting slot 3011d, and the third driving device 3017 is positioned within the fifth mounting groove 3011d. It can be understood that the third driving device 3017 is set in the fifth mounting slot 3011d, and it is not necessary to remove the air inlet hood 3012d or the air outlet hood 3013 to remove the third driving device 3017, which facilitates the disassembly of the third driving device 3017. Preferably, the fifth mounting slot 3011d is set on the air inlet hood 3012d.

Specifically, the fifth mounting slot 3011d is provided with a surrounding wall 3011f, which surrounds to form a receiving space 3011g. A clamping slot 3011h is provided along the surrounding wall 3011f in the receiving space 3011g, and the clamping slot 3011h includes an opening 3011i. On one side of the third driving device 3017, there is a connecting part 3017c, which is arranged in the receiving space 3011g. The connecting part 3017c enters the clamping slot 3011h from the opening 3011i, so that the connecting part 3017c is engaged in the clamping slot 3011h. It can be understood that when installing the third driving device 3017 in the fifth mounting slot 3011d, the connecting part 3017c is set in the receiving space 3011g. Turning the third driving device 3017 causes the connecting part 3017c to enter the clamping slot 3011h from the opening 3011i, so that the third driving device 3017 is engaged in the fifth mounting slot 3011d. Rotate the third driving device 3017 in the opposite direction to disengage the connecting part 3017c in the clamping slot 3011h from the opening 3011i, allowing the third driving device 3017 to be detached from the fifth mounting slot 3011d.

Preferably, there are three connecting parts 3017c, and there are three clamping slots 3011h, which can make the connection between the third driving device 3017 and the fifth mounting slot 3011d more stable.

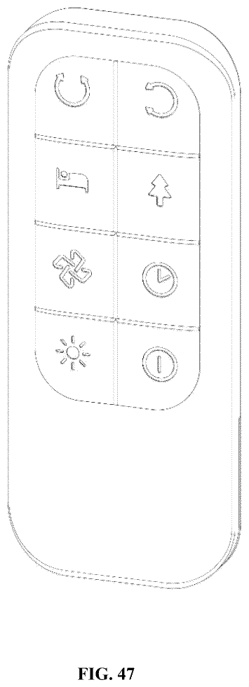

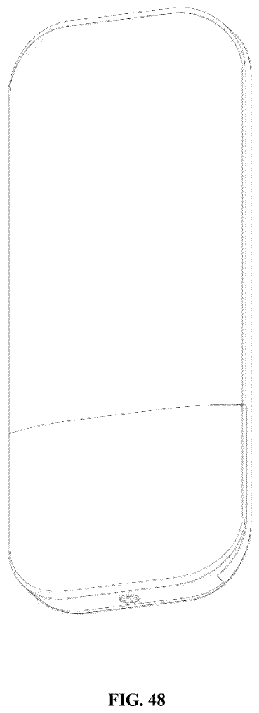

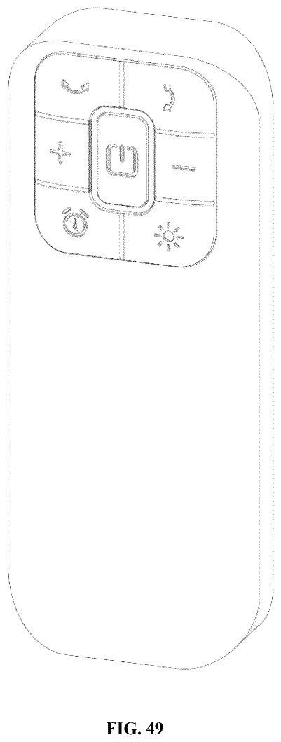

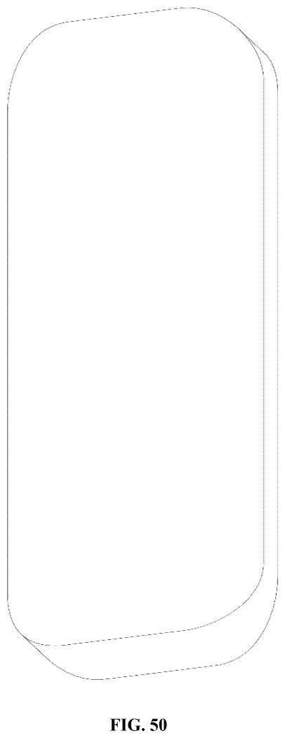

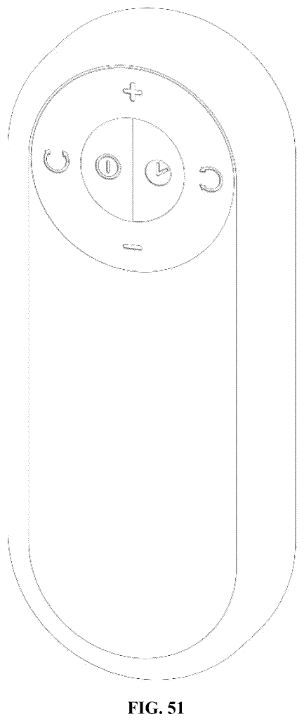

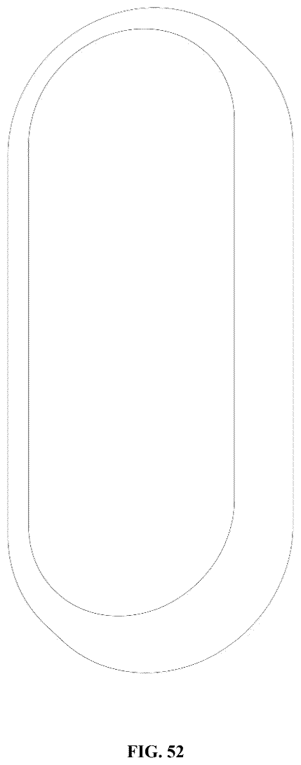

Please refer to FIGS. 47-52, a remote controller 600 is provided for the fan, that is, the fan body 100 can be controlled by the main unit 400 or the remote controller 600. In particular, the fan of the present invention can also be controlled by three different embodiments of a remote controller 600. The remote controller 600 can be rectangular or elliptical in shape and has multiple control buttons on the front, as shown in FIG. 47, the multiple control buttons can include up and down shaking control buttons, left and right shaking control buttons, sleep mode control buttons, outdoor mode control buttons, air volume adjustment buttons, timing control buttons, lighting control buttons, and switch control buttons, which are respectively used to achieve functions such as up and down shaking, left and right shaking, sleep mode, outdoor mode, air volume adjustment, timing control, lighting control, and switch control; as shown in FIG. 49, the switch control key can be located in the central area of the up and down shaking control key, left and right shaking control key, air volume increase control key, air volume decrease control key, timing control key, and lighting control key; as shown in FIG. 51, the up and down shaking control keys, left and right shaking control keys, air volume increase control key, and air volume decrease control key can be arranged around the periphery of the switch control key and timing control key.

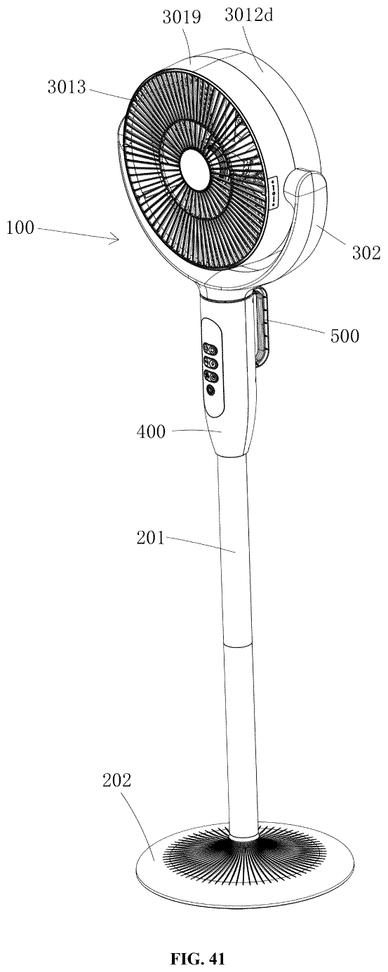

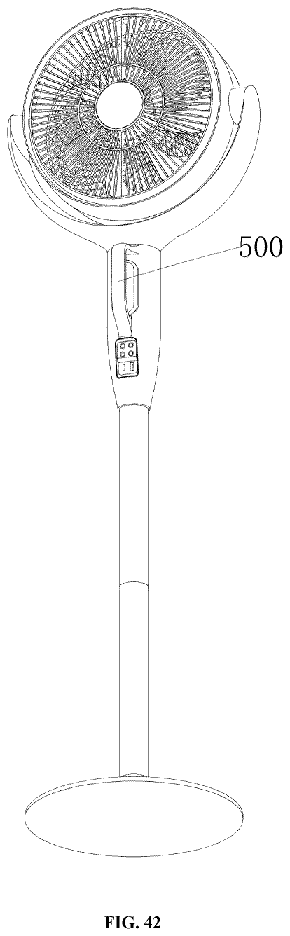

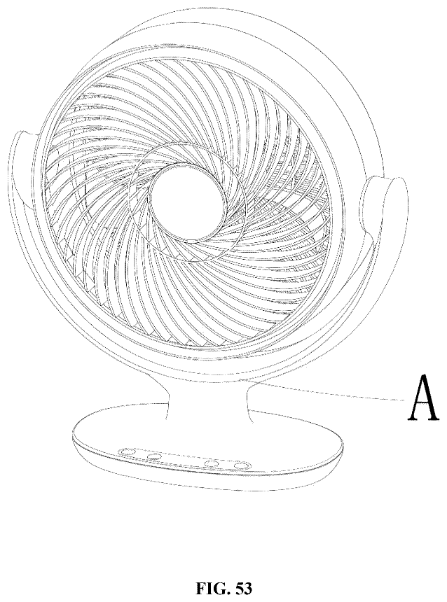

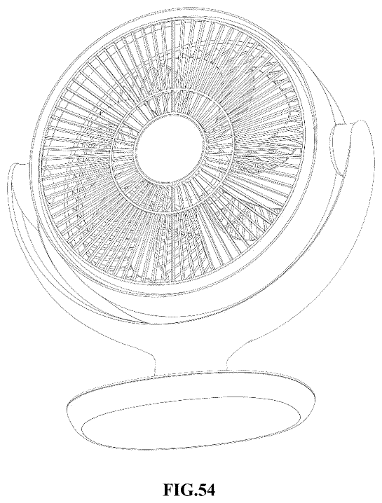

As shown in FIGS. 53 and 54, the fifth embodiment of the present invention also provides a fan. The main difference in the structure and function of the fan compared to the fan of the embodiments shown in FIGS. 41 and 42 is the structure of the bracket assembly. The bracket assembly A of the fifth embodiment has a lower height and can be used for desktop and bedside use.

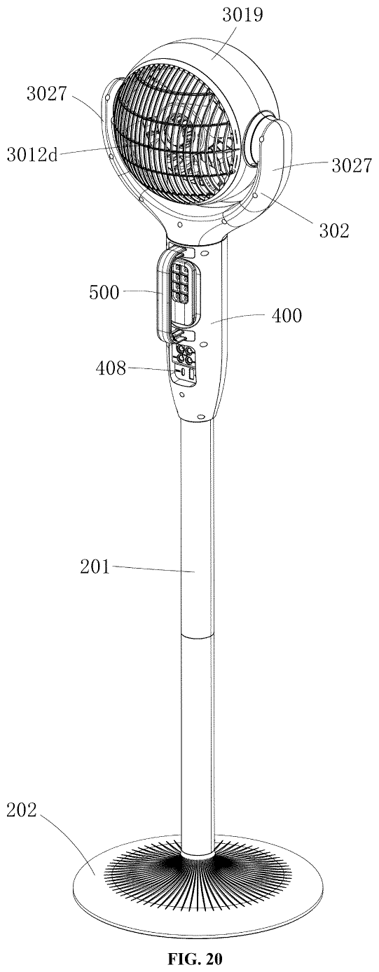

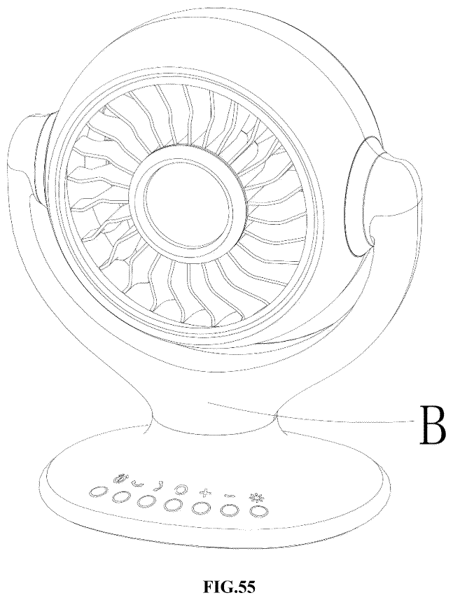

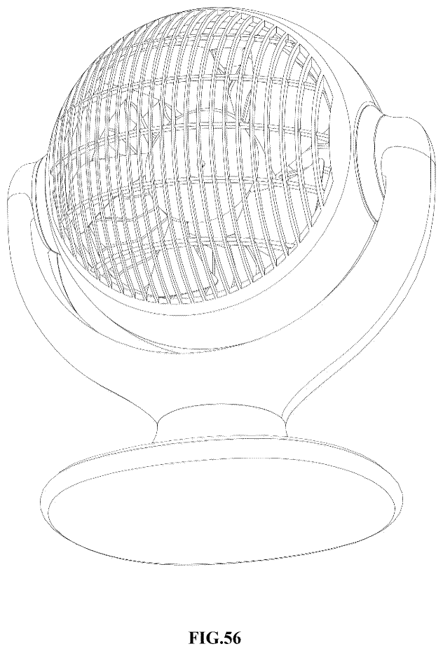

As shown in FIGS. 55 and 56, the sixth embodiment of the present invention also provides a fan. The main difference in the structure and function of the fan compared to the fan of the embodiments shown in FIGS. 18 and 20 is the structure of the bracket assembly. The bracket assembly B of the sixth embodiment has a lower height and can be used for desktop and bedside use.

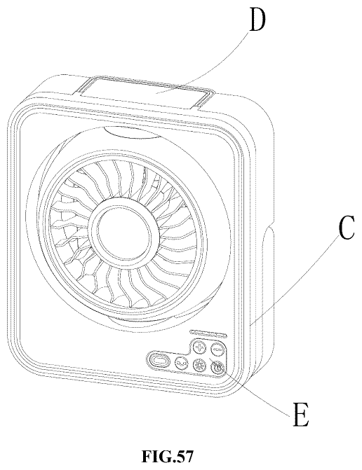

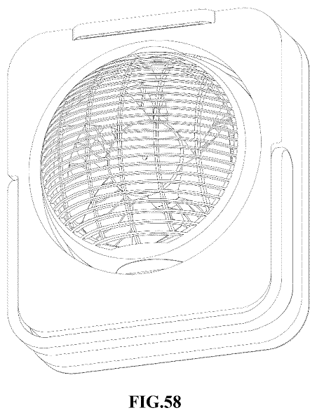

As shown in FIGS. 57 and 58, the seventh embodiment of the present invention also provides a fan. The structure and function of the fan assembly of the fan are basically the same as those of the fan assembly of the embodiments shown in FIGS. 18 and 20, but the bracket assembly C of the seventh embodiment has a lower height, is a rectangular structure, and is surrounded by the periphery of the fan assembly, which can be used for desktop and bedside use. The top of the bracket assembly C can also be provided with a foldable and expandable handle D, and multiple control buttons E are located on the front of the bracket assembly C.

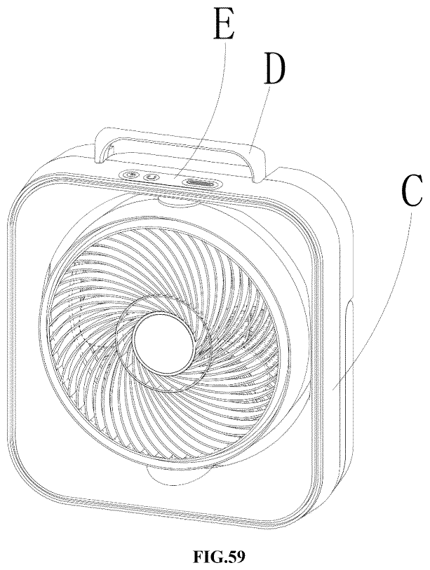

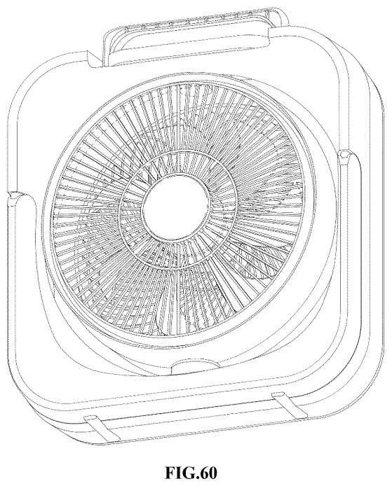

As shown in FIGS. 59 and 60, the eighth embodiment of the present invention also provides a fan. The structure and function of the fan assembly of the fan are basically the same as those of the fan assembly of the embodiments shown in FIGS. 18 and 20, but the bracket assembly C of the eighth embodiment has a lower height, is a rectangular structure, and is surrounded by the periphery of the fan assembly, which can be used for desktop and bedside use. The top of the bracket assembly C can also be provided with a foldable and expandable handle D, and multiple control buttons E are also located on the top surface of the bracket assembly C.

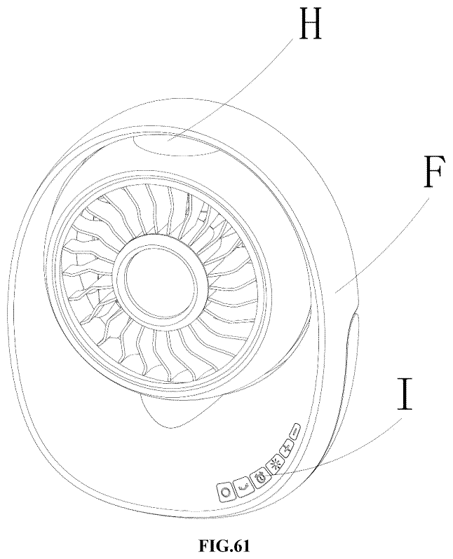

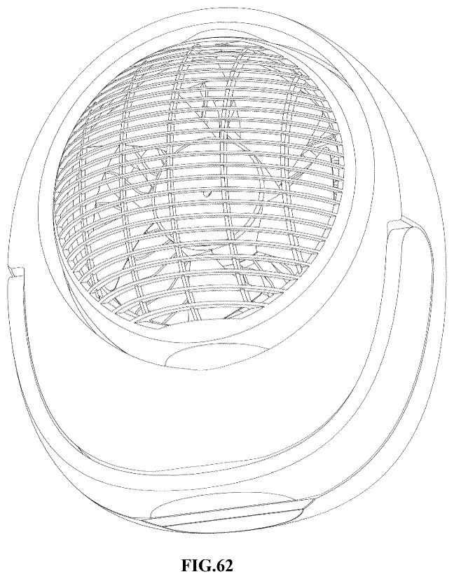

As shown in FIGS. 61 and 62, the ninth embodiment of the present invention also provides a fan. The structure and function of the fan assembly of the fan are basically the same as those of the fan assembly of the embodiments shown in FIGS. 18 and 20, but the bracket assembly F of the ninth embodiment has a lower height, an elliptical structure, and is surrounded by the periphery of the fan assembly, which can be used for desktop and bedside use. The top of the bracket assembly can also be provided with an arc-hole shaped handle H, and multiple control buttons I are located on the front of the bracket assembly F.

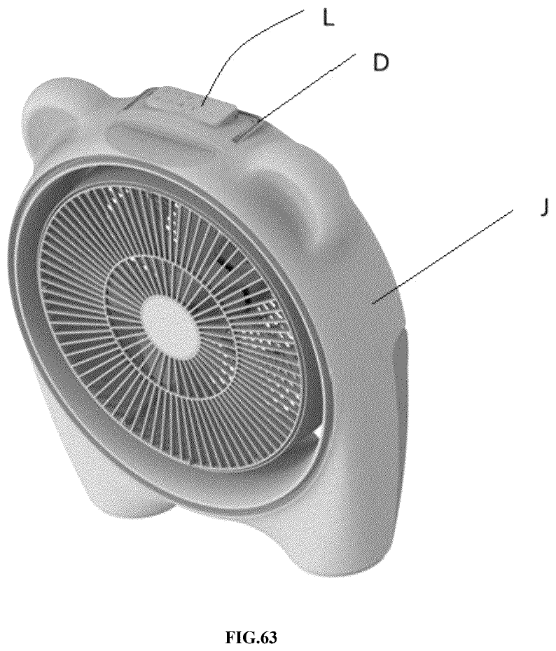

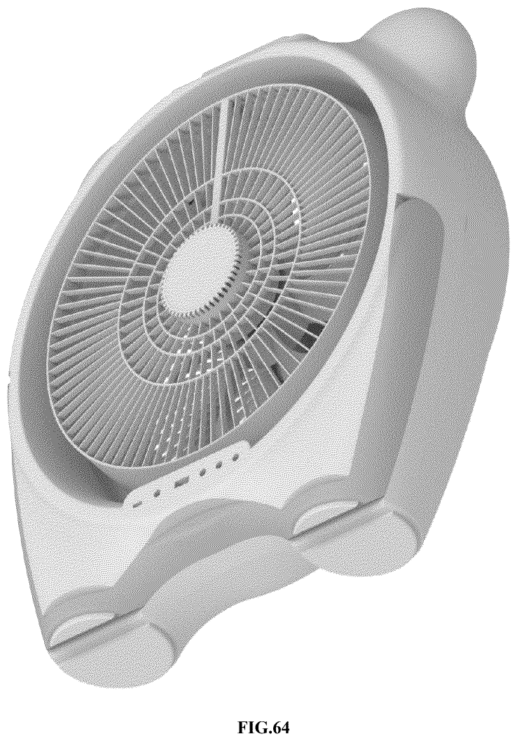

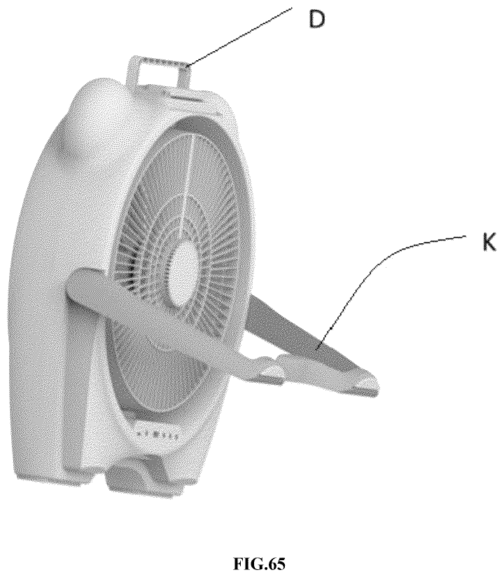

As shown in FIGS. 63, 64, and 65, the tenth embodiment of the present invention also provides a fan. The structure and function of the fan assembly of the fan are basically the same as those of the fan assembly of the embodiments shown in FIGS. 41 and 42, but the bracket assembly J of the tenth embodiment has a lower height, is in the shape of a moving bear, and is looped around the periphery of the fan assembly, which can be used for desktop and bedside use. The top of the bracket assembly J can also be provided with a foldable and expandable handle D. The rear side of the bracket assembly can also be provided with a U-shaped bracket piece K that can be folded, stored, and unfolded for use. The remote controller L can be detachably set in the installation slot on the top of the bracket assembly J.

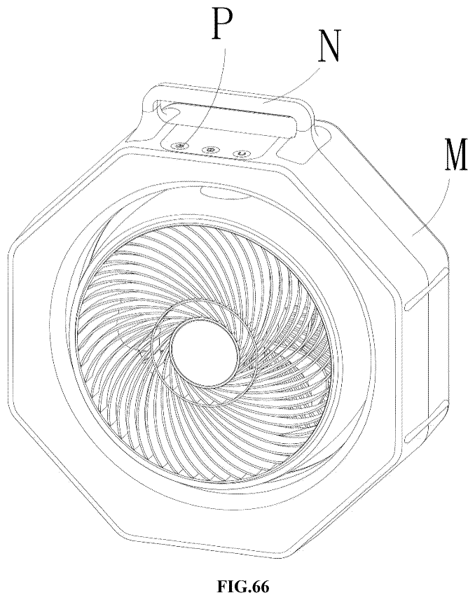

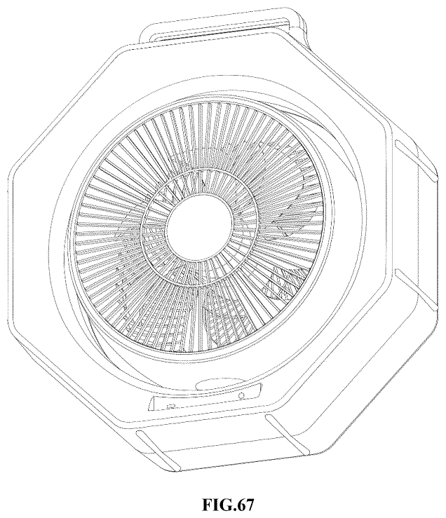

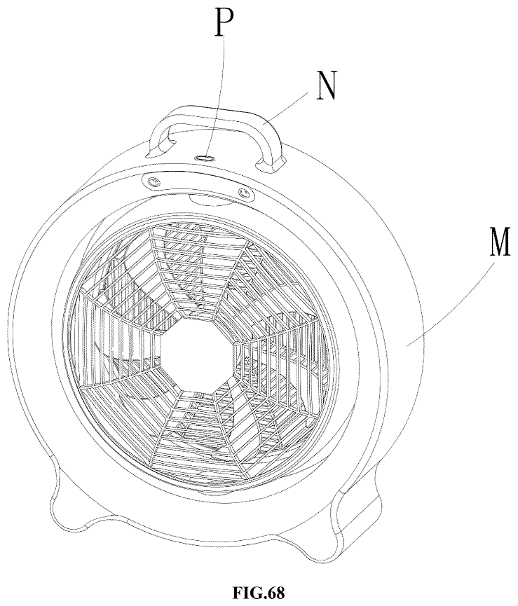

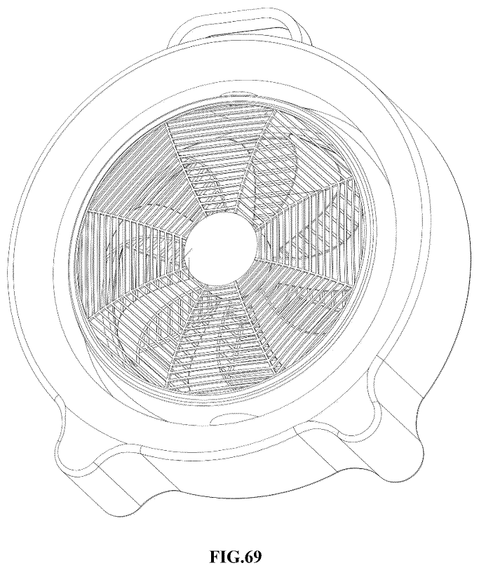

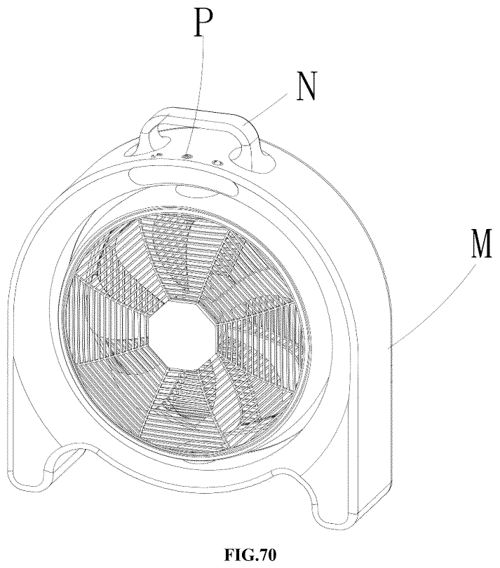

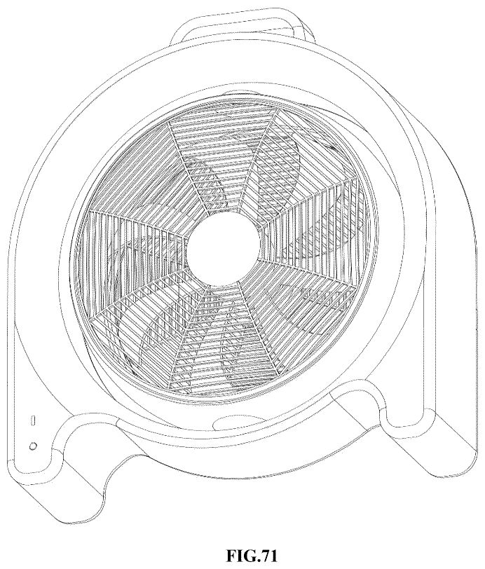

As shown in FIGS. 66-71, the eleven, twelve, thirteen embodiments of the present invention also provides a fan. The structure and function of the fan assembly of the fan are basically the same as those of the fan assembly of the embodiments shown in FIGS. 41 and 42, but the bracket assembly M of each of the eleven, twelve, thirteen embodiments has a lower height, an elliptical structure, and is surrounded by the periphery of the fan assembly, which can be used for desktop and bedside use. The top of the bracket assembly can also be provided with a handle N, and multiple control buttons P are located on the front of the bracket assembly M.

The above description only describes embodiments of the present invention, and is not intended to limit the present invention; various modifications and changes can be made to the present invention. Any modifications, equivalent substitutions, and improvements made within the spirit and scope of the present invention are intended to be included within the scope of the present invention.

What is claimed is:

1. A fan comprising:
a fan body (100);
a bracket assembly (200), connected to and supporting the fan body (100); and
at least one first driving device (1001);
wherein the fan body (100) comprises:
a blower unit (300), comprising a blowing component (301) for blowing and a support bracket (302) rotatably connected to the blowing component (301) and supporting the blowing component (301); and
a main unit (400) arranged between the support bracket (302) and the bracket assembly (200), and configured for controlling the blower unit (300); and
wherein the at least one first driving device (1001) is respectively connected to the blowing component (301) and the support bracket (302) to drive the blowing component (301) rotates relative to the support bracket (302).

2. The fan of claim 1, further comprising at least one second driving device (1002), wherein the main unit (400) is electrically connected to the at least one second driving device (1002) and drives the at least one second driving device (1002), the at least one second driving device (1002) is respectively connected to the support bracket (302) and the main unit (400) to drive the support bracket (302) rotates relative to the main unit (400).

3. The fan of claim 1, wherein the blowing component (301) comprises a first housing (3011), and a first connecting shaft (3012) protruding from an outer side of the first housing (3011); the support bracket (302) comprises a second housing (3021) comprising at least one support arm (3027) used to connect the blowing component (301), and the second housing (3021) is provided with a first shaft hole (3022), the first connecting shaft (3012) is arranged in the first shaft hole (3022);
wherein the fan body (100) further comprises a first bearing (1003) sleeved on the first connecting shaft (3012), and the second housing (3021) comprises a first shell (3021a), a second shell (3021b) detachably connected to the first shell (3021a), and a first bearing slot (3029) connected to the first shaft hole (3022) and configured for accommodating the first bearing (1003), each of the first bearing slot (3029) and the first shaft hole (3022) is partially located in the first shell (3021a) and partially located in the second shell (3021b).

4. The fan of claim 3, wherein a first mounting slot (3023) is provided inside the second housing (3021), which is connected to the first shaft hole (3022); the first driving device (1001) is set in the first mounting slot (3023), so that the first driving device (1001) is detachably connected to the support bracket (302); and the first driving device (1001) is connected to the first connecting shaft (3012) to drive the blowing component (301 relative to the support bracket (302);
wherein the first driving device (1001) comprises a first rotating shaft (1001a), and a first insertion hole (3012a) is provided on the first connecting shaft (3012), the first rotating shaft (1001a) is inserted into the first insertion hole (3012a); and
wherein the first mounting slot (3023) is partially located in the first shell (3021a) and partially located in the second shell (3021b).

5. The fan of claim 2, wherein the support bracket (302) comprises a second housing (3021), which is rotatably connected to the main unit (400); the support bracket (302) is provided with a second connecting shaft (3024) protruding from a bottom of the support bracket (302) near the main unit (400); the main unit (400) includes a third housing (401), which is provided with a second shaft hole (402), the second connecting shaft (3024) is arranged in the second shaft hole (402); and
wherein the fan body (100) further includes a second bearing (1004), which is sleeved on the second connecting shaft (3024); the third housing (401) is provided with a second bearing slot (401a), which is connected to the second shaft hole (402); the third housing (401) comprises a third shell (401b) and a fourth shell (401c) detachably connected to the third shell (401b); the second bearing slot (401a) is partially located in the third shell (401b), and partially located in the fourth shell (401c).

6. The fan of claim 5, wherein a second mounting slot (403) is provided inside the third housing (401), which is connected to the second shaft hole (402); the second driving device (1002) is set in the second mounting slot (403) to allow for a detachable connection between the second driving device (1002) and the main unit (400); the second mounting slot (403) is connected to the second connecting shaft (3024) to drive the support bracket (302) relative to the main unit (400);
the second driving device (1002) comprises a second rotating shaft (1002a), and a second insertion hole (3024a) is provided on the second connecting shaft (3024); the second rotating shaft (1002a) is inserted into the second insertion hole (3024a).

7. The fan of claim 1, wherein the support bracket (302) comprises a second housing (3021), the second housing (3021) is provided with a first shaft hole (3022) and a first mounting slot (3023), the first mounting slot (3023) is connected to the first shaft hole (3022), and the first driving device (1001) is set in the first mounting slot (3023);
a wiring channel (3025) is formed around an inner wall of the second housing (3021), the wiring channel (3025) is connected to the first mounting slot (3023) and the first shaft hole 3022;
a first wire hole (3026) is provided in a bottom of the second housing (3021), which is connected to the wiring channel (3025); external wires are threaded through the wiring channel (3025), the first wire hole (3026), and connected to the first driving device (1001) and the main unit (400), so as to electrically connect the first driving device (1001) and the main unit (400).

8. The fan of claim 7, wherein the main unit (400) includes a third housing (401), which is provided with a second wire hole (4011); the second wire hole (4011) is connected to the first wire hole (3026); the main unit (400) further comprises a control motherboard (404) and control buttons (405);
the control buttons (405) are arranged on the third housing (401), and the control motherboard (404) is arranged inside the third housing (401) and electrically connected to the control buttons (405); external wires are extend through the wiring channel (3025), the first wire hole (3026), the second wire hole (4011), and connected to the first driving device (1001) and the control motherboard (404), so that the first driving device (1001) is electrically connected to the control motherboard (404).

9. The fan of claim 8, wherein the main unit (400) further comprises a circuit board (406), a battery (407), and a charging interface (408); the circuit board (406) and the battery (407) are arranged inside the third housing (401), and the charging interface (408) is arranged on the third housing (401); the charging interface (408) is electrically connected to the circuit board (406), and the battery (407) is electrically connected to the circuit board (406) and the control motherboard (404) respectively.

10. The fan of claim 1, wherein the fan body (100) comprises a sensing device (1005), which is electrically connected to the main unit (400); the sensing device (1005) is configured for detecting a user, and sending an electrical signal to the main unit (400), which controls the blowing component (301) to blow automatically.

11. The fan of claim 10, wherein the main unit (400) comprises a control motherboard (404), which is electrically connected to the blowing component (301) to control the blowing component (301); the sensing device (1005) is set on the control motherboard (404) and is electrically connected to the control motherboard (404);
the main unit (400) comprises a third housing (401), which is provided with a hole (4012); the sensing device (1005) is configured in the hole (4012) and partially exposed to outside.

12. The fan of claim 1, wherein the fan body (100) further comprises a light emitting device (1006); the light emitting device (1006) is set on the blowing component (301) and is electrically connected to the main unit (400) to control work of the light emitting device (1006).

13. The fan of claim 12, wherein the first housing (3011) comprises an air inlet hood (3012d) and an air outlet hood (3013) connected to the air inlet hood (3012d); a third mounting slot (3014) is provided at a central position of the air outlet hood (3013), and the light emitting device (1006) is arranged in the third mounting slot (3014); the light emitting device (1006) includes multiple LED beads (1007) arranged in a circle;
the blowing component (301) further comprises a fixing cover (3015), which is used to cover the light emitting device (1006); the third mounting slot (3014) is provided with a first slot (3014a), and the light emitting device (1006) is provided with a second slot (1006a) corresponding to the first slot (3014a); the fixing cover (3015) is provided with a first plug (3015a), which is inserted into the second slot (1006a) and the first slot (3014a) to fix the light emitting device (1006) in the third mounting slot (3014);
the fixing cover (3015) comprises a translucent lampshade (3015b), which is arranged around an edge of the fixing cover (3015), and a position of the lampshade (3015b) corresponds to a position of the LED beads (1007).

14. The fan of claim 1, wherein the blowing component (301) comprises a first housing (3011), a third driving device (3017) and a blade impeller (3016), and the third driving device (3017) and the blade impeller (3016) are arranged inside the first housing (3011);
the third driving device (3017) is electrically connected to the main unit (400) to drive the blade impeller (3016) to rotate; the blade impeller (3016) is provided with a fourth mounting slot (3016a), and the third driving device (3017) is detachably arranged in the fourth mounting slot (3016a), so that the blade impeller (3016) and the third driving device (3017) is detachably connected;
a fourth connecting shaft (3013a) is provided on one side of the air outlet hood (3013), and a third insertion hole (3013b) is opened on the fourth connecting shaft (3013a); the third driving device (3017) comprises a third rotating shaft (3017a), which is inserted into the third insertion hole (3013b) to allow the third driving device (3017) to be detachably connected to the air outlet hood (3013).

15. The fan of claim 14, wherein a through hole (3016b) is provided in a center of the blade impeller (3016), and a diameter of the through hole (3016b) is smaller than that of the third driving device (3017); the through hole (3016b) is connected to the fourth mounting slot (3016a), and a first connecting part (3017b) is provided on a side of the third driving device (3017) opposite to the third rotating shaft (3017a); the first connecting part (3017b) passes through the through hole (3016b);
the blowing component (301) further comprises a fixing part (3018), which is used to connect with the first connecting part (3017b) and abut against a side wall of the through hole (3016b), so that the blade impeller (3016) and the third driving device (3017) are fixedly connected, and after removing the fixing part (3018) from the first connecting part (3017b), the third driving device (3017) is detachable from the blade impeller (3016);
the first connecting part (3017b) is provided with a first thread (3017c), and an inner wall of the fixing part (3018) is provided with a slider (3018a) that cooperates with the thread (3017c); the slider (3018a) slides on the thread (3017c) to allow the fixing part (3018) to be rotatably connected to the first connecting part (3017b);
an outer wall of the third driving device (3017) is provided with a positioning member (3016c), which is configured to pass through the through hole (3016b); the fixing part (3018) is provided with an annular groove (3018b), when the fixing part (3018) is rotatably connected to the first connecting part (3017b), the positioning member (3016c) slides in the annular groove (3018b).

16. The fan of claim 14, wherein the first housing (3011) is provided a third connecting shaft (3011a) protruding on an outer side thereof; the third connecting shaft (3011a) is rotatably connected to the support bracket (302), and a third wire hole (3011b) is opened on the third connecting shaft (3011a);
a wire slot (3013d) is opened on a side of the air outlet cover (3013) facing the blade impeller (3016), one end of the wire slot (3013d) is connected to the fourth mounting slot (3016a), and the other end of the wire slot (3013d) is connected to the third wire hole (3011b).

17. The fan of claim 14, wherein the first housing (3011) is provided a third connecting shaft (3011a) protruding on an outer side thereof, the third connecting shaft (3011a) is rotatably connected to the support bracket (302), and a third wire hole (3011b) is opened on the third connecting shaft (3011a);
a wire slot (3013d) is opened on a side of the air inlet cover (3012d) facing the blade impeller (3016), one end of the wire slot (3013d) is connected to the fourth mounting slot (3016a), and the other end of the wire slot (3013d) is connected to the third wire hole (3011b);
the blowing component (301) further comprises a cover plate (3011c), which is used to cover the wire slot (3013d).

18. The fan of claim 1, wherein the blowing component (301) comprises a blade impeller (3016), an air inlet hood (3012d), and an air outlet hood (3013), the blade impeller (3016) is located between the air inlet hood (3012d) and the air outlet hood (3013); the blade impeller (3016) rotates to draw in air from the air inlet hood (3012d), forming an airflow and blowing out from the air outlet hood (3013);
the air outlet hood (3013) comprises multiple air guide plates (3013g) arranged in a circular pattern; the air guide plates (3013g) are used to gather the airflow and blow out along a rotation axis A-A direction of the blade impeller (3016); and the air guide plate (3013g) comprises a first section (3013c), a second section (3013j) and a third section (3013e) connected in sequence with a bending degree of between adjacent sections and each section having a certain length and width, and a width direction of each of the first section (3013c), second section (3013j) and third section (3013e) is parallel to the rotation axis A-A direction of the blade impeller (3016), to guide the airflow direction to be parallel to the rotation axis A-A direction of the blade impeller (3016);
the air outlet hood (3013) further comprises an air gathering ring (3013f), which is arranged around the air outlet side of the air outlet hood (3013); a diameter of the air gathering ring (3013f) on the side away from the air outlet hood (3013) is smaller than a diameter of the air gathering ring (3013f) on the side connected to the air outlet hood (3013), so that the airflow blown out through the air outlet hood (3013) is guided and converged by the air gathering ring (3013f).

19. The fan of claim 1, wherein the blowing component (301) comprises an air inlet hood (3012d), a middle shell (3019), an air outlet hood (3013), the middle shell (3019) is detachably connected to the air inlet hood (3012d) and the air outlet hood (3013) respectively;
the middle shell (3019) comprises a first sliding groove (3019a), and a second plug (3012a) is provided on the air inlet cover (3012d), which slides in the first sliding groove (3019a); the first sliding groove (3019a) is provided with a first sliding strip (3019b), which is provided with a first convex portion (3019c); the second plug (3012a) is provided with a second sliding strip (3012b), which is provided with a second convex portion (3012c); the second plug (3012a) slides in the first sliding groove (3019a), causing the first sliding strip (3019b) and the second sliding strip (3012b) to come into contact and slide against each other until the first convex portion (3019c) and the second convex portion (3012c) are pressed against each other, and the first sliding strip (3019b) and the second sliding strip (3012b) are locked to each other.

20. The fan of claim 1, further comprising a handle (500) mounted on the main unit (400), wherein the bracket assembly (200) comprises a support rod (201) and a base (202), one end of the support rod (201) is connected to the main unit (400), and the other end of the support rod (201) is connected to the base (202); the base (202) is used to support the fan body (100); multiple reinforcing ribs (2021) are arranged on the base (202) in a circular pattern;
the blowing component (301) comprises a first housing (3011), and a third driving device (3017), an outer wall of the first housing (3011) is inwardly recessed to form a fifth mounting slot (3011d), and the third driving device (3017) is positioned within the fifth mounting groove (3011d);
the fifth mounting slot (3011d) is provided with a surrounding wall (3011f), which surrounds to form a receiving space (3011g); a clamping slot (3011h) is provided along a surrounding wall (3011f) in the receiving space (3011g), and the clamping slot (3011h) includes an opening (3011i), one side of the third driving device (3017) is provided with a connecting part (3017c), which is arranged in the receiving space (3011g); the connecting part (3017c) enters the clamping slot (3011h) from the opening (3011i), so that the connecting part (3017c) is engaged in the clamping slot (3011h); and
the blowing component (301) comprises an air inlet hood (3012d), the fifth mounting slot (3011d) is formed in the air inlet hood (3012d).
